(19) United States
(12) Patent Application Publication
(10) Pub. No.: US 2026/0003848 A1
(43) Pub. Date: Jan. 1, 2026

(54) Memetic Database

(71) Applicant: Holtwork LLC, Incline Village, NV (US)

(72) Inventor: Brian Holt, Incline Village, NV (US)

(73) Assignee: Holtwork LLC, Incline Village, NV (US)

(21) Appl. No.: 19/317,067

(22) Filed: Sep. 2, 2025

Related U.S. Application Data
(63) Continuation of application No. 18/814,486, filed on Aug. 24, 2024.
(60) Provisional application No. 63/534,798, filed on Aug. 25, 2023.
(60) Provisional application No. 63/760,077, filed on Feb. 18, 2025.
(60) Provisional application No. 63/805,943, filed on May 14, 2025.
(60) Provisional application No. 63/837,824, filed on Jul. 2, 2025.

(51) Int. Cl. G06F 16/22

(52) U.S. Cl. CPC G06F 16/2282

(57) ABSTRACT

Computer-implemented techniques for representing, storing, retrieving, and reasoning over knowledge are disclosed herein. One aspect is an axis-lattice query language paradigm that turns every query string into a rectangular Matrix→Vector→Limit→Data tensor whose shape is dictated by token position. The invention improves the operations of a computing device by increasing the amount of significant information manipulated per unit of time by a processor.

### CROSS REFERENCES TO RELATED APPLICATIONS

The Present Application is a continuation-in-part of U.S. patent application Ser. No. 18/814,486, filed on Aug. 24, 2024, which claims priority to U.S. Provisional Patent Application No. 63/534,798, filed on Aug. 25, 2023, now expired, and the Present Application claims priority to U.S. Provisional Patent Application No. 63/837,824, filed on Jul. 2, 2025, U.S. Provisional Patent Application No. 63/805,943, filed on May 14, 2025, and U.S. Provisional Patent Application No. 63/760,077, filed on Feb. 18, 2025, each of which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention relates to computer-implemented techniques for representing, storing, retrieving, and reasoning over knowledge. It particularly concerns (i) knowledge-graph and database architectures, including relational, graph, hybrid No-SQL stores, and document-search systems; (ii) artificial-intelligence tooling such as computer-learning models, artificial neural networks, and large language model (LLM) retrieval-augmented generation (RAG) pipelines that consume or emit said knowledge; and (iii) the formal underpinnings that govern these systems, encompassing computer-programming languages, category theory, type theory, modal and other formal logics, database theory, graph theory, relational algebra, and associated metalanguages.

### Description of the Related Art

Conventional computer-implemented information systems employ several distinct data models, each accompanied by its own storage structures, query languages, and reasoning techniques. In the relational model, data are stored in normalized tables addressed by the Structured Query Language (SQL), a declarative language codified in successive editions of the ISO/IEC 9075 standard. Key-value stores, column-family stores, and document databases relax strict normalization to accommodate variable-schema records and high write throughput.

Graph-oriented stores treat information as vertices linked by directed edges. Property-graph databases assign labels and key-value properties to both vertices and edges; commercial implementations provide traversal operations that evaluate adjacency patterns with short execution times even on large, partitioned graphs. The Graph Query Language (GQL) standard defines data-definition and query constructs for property graphs and incorporates features pioneered by vendor dialects such as Cypher and PGQL. Cypher adopts an ASCII-art pattern-matching syntax, whereas Gremlin, specified by the Apache TinkerPop project, supplies an imperative traversal language that can be executed step by step. Other client-facing query technologies, such as GraphQL, project sub-graphs over heterogeneous back ends by allowing a requester to specify the shape of the desired response.

The World Wide Web Consortium's Resource Description Framework (RDF) expresses facts as subject-predicate-object triples. The SPARQL Protocol and RDF Query Language (SPARQL) provides declarative constructs for graph-pattern matching, federated joins across distributed endpoints, and update operations. Ontology languages that extend RDF, including the Web Ontology Language (OWL), enable the definition of class hierarchies, property characteristics, and logical constraints that support automated classification and consistency checking.

Symbolic knowledge-based systems pre-date many of the foregoing web and graph standards. One representative example is the Cyc project, which maintains a curated ontology comprising typed predicates, micro-theories, and inference rules encoded in the CycL language. Cyc's rule-engine applies deductive, abductive, and default reasoning to derive conclusions from asserted axioms. Logic-programming languages such as Prolog and Datalog likewise manipulate facts and rules, evaluating Horn clauses through resolution or semi-naïve bottom-up algorithms.

In parallel with symbolic approaches, vector-embedding databases store high-dimensional numeric vectors that represent words, sentences, images, or other artefacts in continuous latent spaces. These stores implement approximate-nearest-neighbor algorithms to answer similarity queries and are frequently employed to retrieve context for large language models in retrieval-augmented generation pipelines. Emerging products embed vector representations inside graph nodes, thereby combining topological structure with semantic proximity.

Although each of the foregoing technologies addresses specific workload requirements, practitioners confront persistent difficulties. Schema and logic remain fragmented across relational, document, property-graph, triple, and vector stores; equivalent facts are duplicated in multiple grammatical or directional forms; inverse-relationship traversals and class-hierarchy reasoning can incur significant run-time cost; and data pipelines that move information between symbolic knowledge structures and sub-symbolic embeddings introduce brittleness and latency. As a result, constructing a single system that stores data compactly, executes graph and logical queries efficiently, and supplies concise, unambiguous context to artificial-intelligence models remains a challenging task.

### BRIEF SUMMARY OF THE INVENTION

The present invention describes efficient and flexible methods of storing, computing, and communicating knowledge.

One aspect of the present invention is an axis-lattice query language paradigm that turns every query string into a rectangular Matrix→Vector→Limit→Data tensor whose shape is dictated by token position. Low-character separators and positional cues replace the verbose keywords and quoted identifiers of conventional languages, shrinking multi-clause queries to a handful of symbols. Results are optionally emitted in the same syntax so downstream prompts can chain queries without re-serialization, reducing context-window usage. Concise pointer dereference tokens inline joins and filters, further trimming token count, lowering per-token entropy, and localizing attention.

Another aspect of the present invention is a deterministic compiler framework that defines a rectilinear query language built on a fixed four-axis lattice. It unifies the semantics of tables and graphs yet can expand to higher dimensions when required. The compiler parses each statement in a single pass into rectangular matrices whose row, vector, and cell limits map directly to GPU-aligned tensors. Variables bind to axis coordinates at parse time, so substitutions resolve through constant-time indexing instead of late-bound joins. Wildcards and difference markers are desugared into a minimal operator set during scanning, which simplifies execution. The engine then serializes results back in the same query grammar, turning every output into immediate, valid input. This feedback loop removes intermediate result formats, supports recursive analytics, allows lossless translation to SQL and SPARQL, enables storage as fixed-width disk pages, and provides forward-compatible extension to hyperdimensional data models without schema redesign.

In one embodiment, the present invention improves the operations of a computing device by increasing the amount of significant information stored per unit of space on non-transitory computer-readable storage medium. In one embodiment, the present invention improves the operations of a computing device by increasing the amount of significant information manipulated per unit of time by a processor. In one embodiment, the present invention improves the operations of a computing device by reducing the amount of redundant, meta, and otherwise insignificant information stored/processed in the device.

In another embodiment, the present invention is used to train a large language model.

In another embodiment, the present invention is used in a large language model retrieval-augmented generation pipeline. A user inputs a natural language query, the LLM transcribes that query into a programmatic query, executes the programmatic query against a datastore, reads the results, then emits the results in natural language form to the user. The present invention reduces the token count, and thus LLM compute costs, of the generating programmatic query and reading datastore results. Further the present invention enables a lower-parameter count LLM to accurately generate more complex queries, further reducing compute costs.

In another embodiment, the present invention is a component of a neural network.

In another embodiment, the present invention provides responses to queries made to virtual assistants or chatbots such as OpenAI® ChatGPT™, Apple® Siri®, or Amazon® Alexa®.

In another embodiment, the present invention provides responses to search engine queries.

In another embodiment, the present invention stores business information, such as customer relationship management (CRM) data, and provides business intelligence responses and metrics.

In another embodiment, the present invention is used for inventory management and product assembly. A factory stores a number of components from suppliers. Each supplier's component is related to a component type. The component type is related to information necessary for the placement of that component with others in an assembly, such as size, weight, and connection elements. Factory robots access this information in order to correctly manipulate and build a given assembly. The present invention stores such information for a hierarchy of components for modular assembly. For example, a certain integrated circuit (IC) from a supplier is related by the present invention to an IC type specifying the number of pins and mounting type of surface-mount technology (SMT) or through-hole technology (THT). A factory robot accesses those details and physically mounts that IC to a printed circuit board (PCB) accordingly. The assembled PCB board is then considered a modular component that is related to a certain type in the present invention. The factory robot then accesses the details for this modular component type to connect the PCB to a 3D-printed plastic form using certain nuts and bolts at certain points. The robot continues to recursively assemble larger modules until the product is complete.

In another embodiment, the present invention is implemented on a blockchain. A given identifier is associated with permissions for one or more blockchain addresses to cryptographically sign messages which create, update, or delete information associated with that identifier. Messages are recorded by mining servers which authenticate, timestamp, and broadcast these messages. Optionally, the miners periodically group messages into blocks and cryptographically sign or hash these blocks. Optionally, multiple blockchains co-exist with certain identifiers only existing on a subset of the blockchains.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF SEVERAL VIEWS OF THE DRAWINGS

FIG. 1 illustrates a graphical ARB data relationship.

FIG. 2 illustrates a complex graphical ARB data relationship.

FIG. 3 illustrates a column/row ARB data relationship.

FIG. 4A illustrates a column/row representation of an ARB meta data.

FIG. 4B illustrates an input form based on the meta data in FIG. 4A.

FIG. 5 illustrates a human language template populated by ARB data.

FIG. 6 illustrates a dynamic ARB relationship using meta relationships.

FIG. 7 illustrates an inverse ARB relationship.

FIG. 8 illustrates business logic and meta relationships.

FIG. 9 illustrates a computer-readable storage medium (CRSM) efficiently storing ARB data.

FIG. 10 illustrates ARB data sharded over multiple shards.

FIG. 11 illustrates an identifier assignment scheme.

FIG. 12 illustrates a command scheme for manipulating data.

FIG. 13 illustrates an ARB logic notation.

FIG. 14 illustrates another ARB logic notation.

FIG. 15 illustrates another ARB logic notation.

FIG. 16 illustrates another ARB logic notation.

FIG. 17 illustrates a logic box.

FIG. 18 Illustrates queries in terms of sets of As, Rs, and Bs.

FIG. 19A Illustrates ARB relationships on a Cartesian plane.

FIG. 19B Illustrates ARB relationships on a Cartesian plane.

FIG. 20 illustrates an ACDB logic notation.

FIG. 21 illustrates a key-value-like logic notation.

FIG. 22 illustrates a hexagonal visualization of ARM logic notation.

FIG. 23 illustrates an alternate variable system for FIG. 21.

FIG. 24 illustrates an axis-based logic notation.

### DETAILED DESCRIPTION OF THE INVENTION

Those skilled in the art will recognize the included drawings provide only a few illustrative examples of possible embodiments of the present invention. It is to be understood that the scope of the present invention includes the many combinations, modifications, and embodiments that may be derived from these drawings. Elements of these drawings are conceptual representations of computer processes which those skilled in the art will recognize as a combination of computer software and hardware. Certain similar elements are given the same reference number across drawings, it is to be understood that aspects of these elements may differ somewhat according to the needs of the particular embodiment.

Unless otherwise indicated, “comprising” is used in an open, non-limiting sense, “or” is inclusive, and the singular includes the plural and vice versa. The techniques described herein may be implemented as a method, as a system comprising one or more machines, and/or as instructions stored on a non-transitory computer-readable medium executed by one or more processors. Any feature described with respect to one embodiment may be combined with any other feature or embodiment where technically compatible, and omissions of features are expressly contemplated. Operations may be performed in the order shown, in a different order, or in parallel, while achieving substantially equivalent results. Deployments may be on-device, on-premises, in cloud or edge environments, single-or multi-tenant, and may include encrypted storage and transport with role-based access control.

Those skilled in the art will recognize this code may be embodied in many equivalent forms and the form below is but one illustrative embodiment. Further, those skilled in the art will recognize the precise machine execution of this code will vary from system to system and may be optimized for various factors.

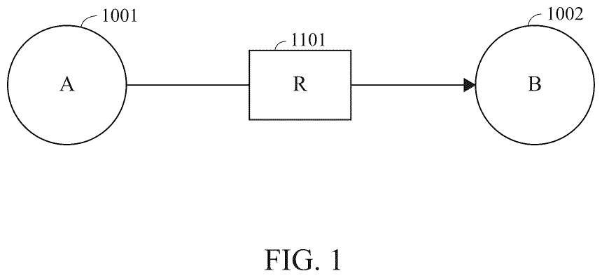

FIG. 1 illustrates a basic ARB meme. In this example, some element A 1001 has some relation R 1101 to some other element B 1002. In one embodiment, this graph is transcribed as (A R B). In one example, A 1001 represents Alice, R 1001 represents parent, and B 1002 represents Bob, which could be verbalized as “Alice is the parent of Bob.” The A 1001 and B 1002 elements typically represent nouns such as people, places, things, ideas, and categories thereof. These elements may be proper nouns or common nouns. The same element may be used in an A 1001 or B 1002 position based on the specific R 1101. The R 1101 typically represents a verb or verb phrase such as “is the parent of” or “has headquarters at” or “is a kind of.” The R 1101 has a specific direction such that the A 1001 and B 1002 are not necessarily swappable. Each ARB is logically unique such that no additional information is learnt from adding an identical ARB meme. Each ARB may be termed a meme or a triplet. In conventional computer terminology, an ARB may be termed a specific form of a row, or a specific form of a tuple.

In one embodiment, A 1001 and/or B 1002 represents an internal identifier with no semantic meaning outside the system. For example, a row identifier, fact identifier, meme identifier, or primary key.

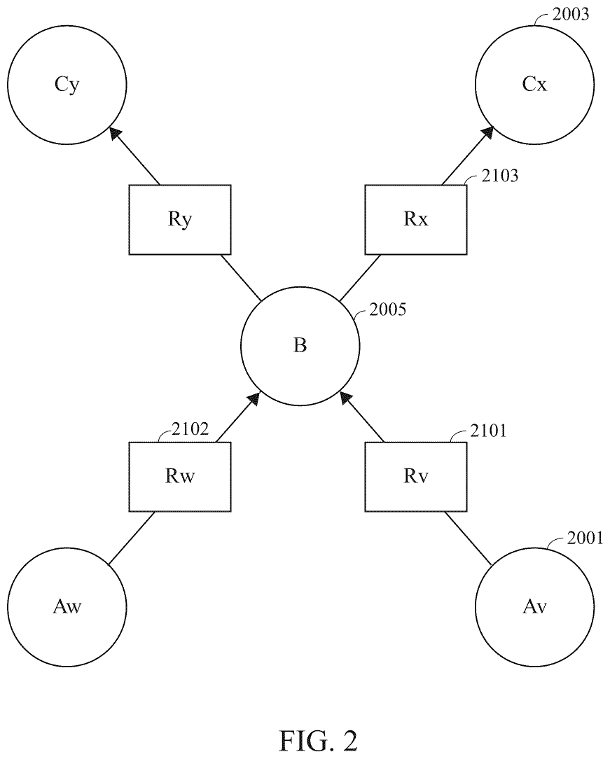

FIG. 2 shows a graphical representation of an ARB memeplex. In one embodiment, this graph is transcribed as (Av Rv B; Aw Rw B; B Ry Cy; B Rx Cx). In this example, Av 2001 is connected to B 2005 by an Rv 2101 relation. The B 2005 value is further connected to the Cx 2003 element through an Rx 2103 relation.

In one embodiment, the Rv value 2101 equals the Rw value 2102, indicating the same relationship. In another embodiment, the Rv value 2101 differs from the Rw value 2102, indicating the distinct relationships. Any given A value is optionally connected to one or many RB pairs. Any given B value is optionally connected to one or many AR pairs.

In one example, the Rx 2103 is verbalized as a phrase linking two sentences or clauses; for example, “as cited by” or “according to.”

In a hierarchical embodiment, the B element represents one scale of information larger than the A elements. In this embodiment, A elements and B elements typically do not exist on the same hierarchical level of the graph. Likened to a graph database, the A element is analogous to a node and the B element is analogous to a graph. Likened to a relational database, the A element is analogous to a cell and the B element is analogous to a row. Likened to a neural network, the A element is analogous to a neuron and the B type is analogous to a network.

In one embodiment, an A element represents a letter or a group of letters (i.e. tokens), while a B element represents a word, name, or short phrase. In another embodiment, an A element represents a word, names, or short phrase, while a B element represents a sentence or clause. In another embodiment, an A values represents sentences and clauses, while a B element represents a long multi-clause sentence, multiple sentences, or a paragraph. In another embodiment, an A element represents a paragraph while a B element represents an article or page. In yet another embodiment, these levels are layered together, such that a B value represents a word, a C value represents a sentence, a D value represents a paragraph, and so forth. It is to be understood that the methods disclosed herein are applicable at many ARB scales and should not be limited to the given example scale.

In a heterarchical embodiment, there are no graph levels and there is no distinction between the scale of the A elements and B elements. This paradigm forms a graph/network structure.

In one embodiment, an ARB is associated with a sequence number (first, second, third, etc.) for display or execution purposes. In one embodiment, an ARB is associated with a weight value similar to a synapse weight in a neural network (e.g. a value between zero and one). The weight optionally indicates the strength of belief in the R relationship between that particular A and B.

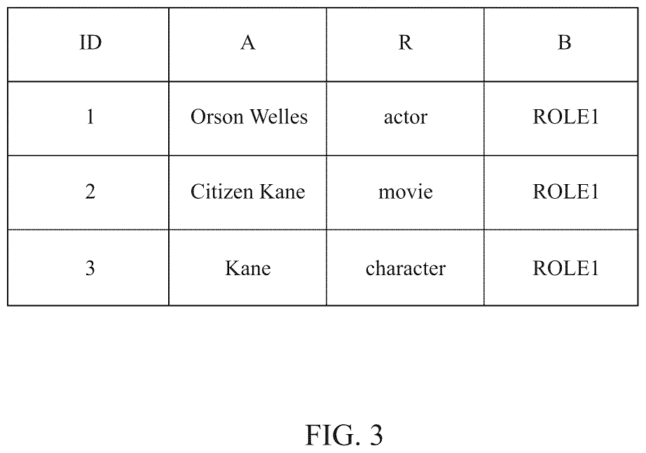

FIG. 3 shows a column/row representation of an ARB data relationship. The data shown represents a sentence akin to “Orson Welles acts as the character Kane in the movie Citizen Kane.” Collectively, these describe a movie role. The first column represents an identifier for each ARB. The second column represents an A value. The third column represents an R value. The fourth column represents a B value. Each ARB here has the same B value, indicating they are associated with the same role. The first ARB indicates that Orson Welles is the actor. The second ARB indicates that Citizen Kane is the movie. And the third ARB indicates that Kane is the character.

In this example, the A, R, and B values are words for ease of understanding. In an alternate embodiment, A, R, and B are identifiers which are associated with human language words stored elsewhere. The identifiers are optionally numeric or alphanumeric.

Embodied in SQL, the A, R, and B are optionally stored as integer identifiers in a table described as: CREATE TABLE ‘ARB’ (‘A’ BIGINT(20) UNSIGNED NOT NULL, ‘R’ BIGINT(20) UNSIGNED NOT NULL, ‘B’ BIGINT(20) UNSIGNED NOT NULL, UNIQUE KEY (‘A’, ‘R’, ‘B’));

One SQL query for getting all ARBs for memes associated with one A value $AID from this table is: SELECT*FROM ‘ARB’ WHERE ‘B’ IN (SELECT ‘B’ FROM ‘ARB’ WHERE A=$AID);

In an alternate embodiment, the present invention uses a no-SQL database engine such as MongoDB, key-value store such as Redis, or wide-column database engine such as Cassandra. In an alternate embodiment, the present invention uses a purpose-built database engine. Ideally, a purpose-built database engine would be optimized for the specific data storage requirements and queries of the present invention.

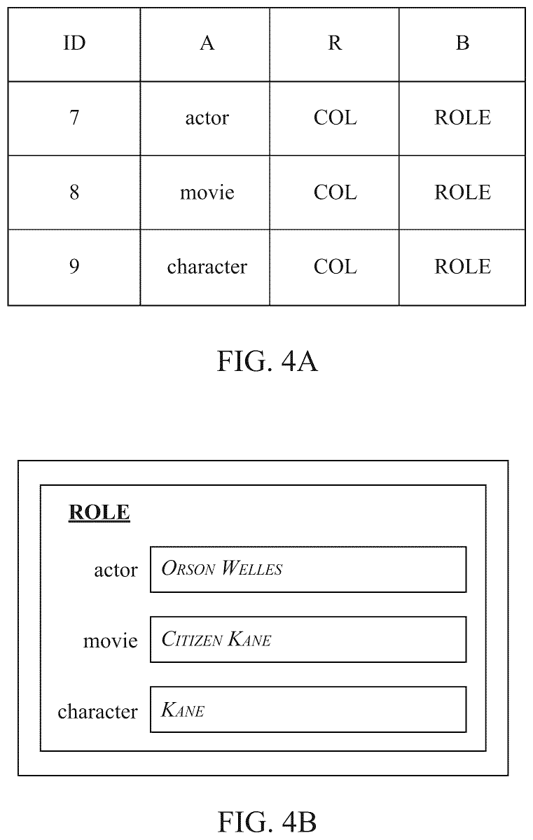

FIG. 4A shows a column/row representation of an ARB meta data. Meta data describes how standard ARB data is inputted or outputted. This meta data forms a meta table with meta columns which is used in entering, displaying, and retrieving the data from FIG. 3. The A values in FIG. 4A correspond to the R values from FIG. 3. The R values here indicate a meta column relationship. And the B value of ROLE connects each column to one meta table. This meta data is optionally stored in the same database table (or equivalent) as the main data or it is optionally stored in a different database table.

FIG. 4B shows an entry form based on the meta data in FIG. 4A. In this example, a user enters the data that will populate FIG. 3. Optionally, new elements are given an incremental id number using a command such as SQL's LAST_INSERT_ID( ).

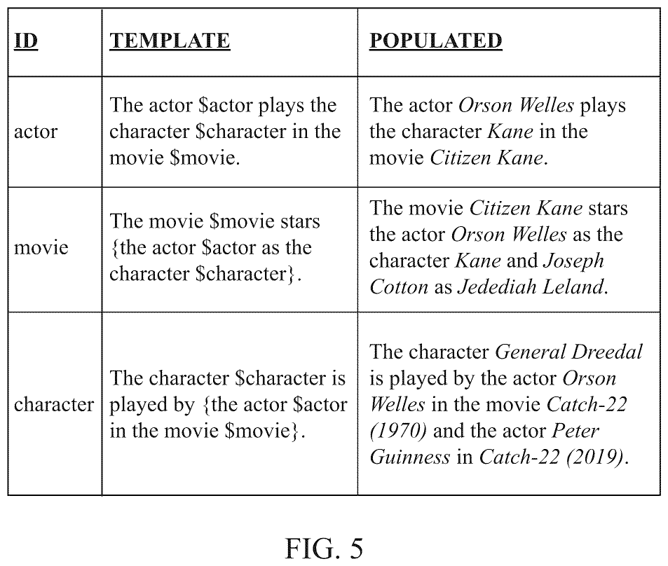

FIG. 5 shows a human language template populated by a meme's data. The first column shows an identifier. The second column shows a human language template. The template comprises variable signifiers associated with R values which will be populated with the paired A value from the meme. Typically, the variable signifier comprises an identifier associated with the R value and optionally one or more special characters; here they are formed as dollar sign and R name. The third column shows the template populated with meme data to form a sentence. The first row is a template verbalized from the perspective of one A value associated with the actor R value. The template is populated with meme data from FIG. 3 to form a sentence. The second row is a template verbalized from the perspective of one A value associated with the movie R value. Optionally, this template combines multiple memes from the same meta table (FIG. 4A) having the same A value paired with the movie R value. When combining memes into one sentence, the clause in curly brackets is repeated for each meme. In this case, the non-subject actor and character variables are in the curly brackets, and that clause is repeated twice in the sentence for the two character-actor AR pairs in the meme. It is to be understood that template formatting is arbitrary where characters such as the dollar sign or curly brackets may be replaced by other characters. Optionally, the templates are encoded in a markup language such as HTML or Markdown.

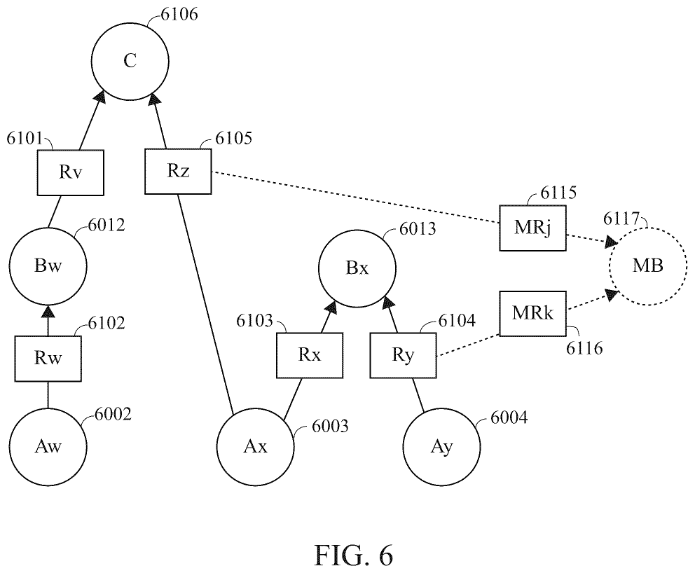

FIG. 6 shows a graphical representation of a dynamic ARB relationship using meta relationships. This example dynamically creates a relation between the Ay 6004 and the C 6106 without previously having an ARB written to CRSM. This creates a logic pattern that can be reused. The Aw 6002 is related by Rw 6102 to Bw 6012. The Bw 6012 is related by Rv 6101 to C 6106. C 6106 is inversely related by Rz 6105 to Ax 6003. The Ax 6003 is related by Rx 6103 to Bx 6013. The Rz 6105 is also meta related by MRj 6115 to the meta MB 6117. The MB 6117 is related by MRk 6116 to Ry 6104. The graph is transcribed in one embodiment as (Aw Rw Bw; Bw Rv C; Ax Rz C; Ax Rx Bx; Ay Ry Bx; Rz MRj MB; Ry MRk MB).

Upon execution, the program searches for ARBs where the B type equals the C value 6106. One result ARB comprises Ax 6003, the Rz 6105, and C 6106. The program stores the Ax value 6003.

The program searches for meta ARBs (mARBs) where the A type equals the second Rz value 6105. One result mARB comprises Rz 6105, MRj 6115, and MB 6117. The program stores the MB value 6117.

The program searches for mARBs where the B type equals the MB value 6117. One result mARB comprises Ry 6104, MRk 6116, and MB 6117. The program stores the Ry value 6104.

The program searches for ARBs where A equals Ax 6003. One result ARB comprises Ax 6003, Rx 6103, and Bx 6103. The program stores the Bx value 6013.

The program searches for ARBs where the R type equals the third Ry value 6104 and the B type equals Bx 6013. This effectively searches for the unknown Ay value 6004 connected to the known Ry value 6104 and the known Bx value 6013. One result ARB comprises Ay 6004, Ry value 6104, and Bx 6103. The program stores the third Ay value 6004. Now the third Ay value 6004 can be used to inform the C 6106.

Here the term “stores” typically indicates reading the value from a slower CRSM and writing the value to a faster CRSM. For example, the program reads from an HDD and records to RAM. Or, for example, the program reads from RAM and records to the processor's cache. The term “search” indicates reading from a CRSM.

In certain embodiments, the ARB relationships are conceptualized as a hierarchy and mARB relationships are conceptualized as an intersecting perpendicular hierarchy.

In one embodiment, these meta relationships describe logical relationships such as family (e.g. parent, child, cousin) or group (e.g. kingdom, phylum, order, class, genus, species). This allows the program to search or display logically related information for a given element without having to permanently store logically redundant ARB relationships.

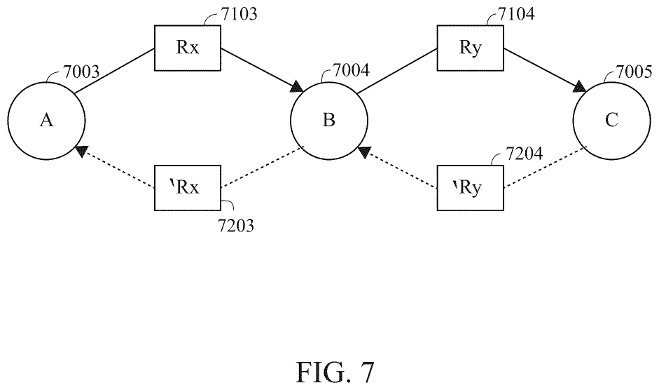

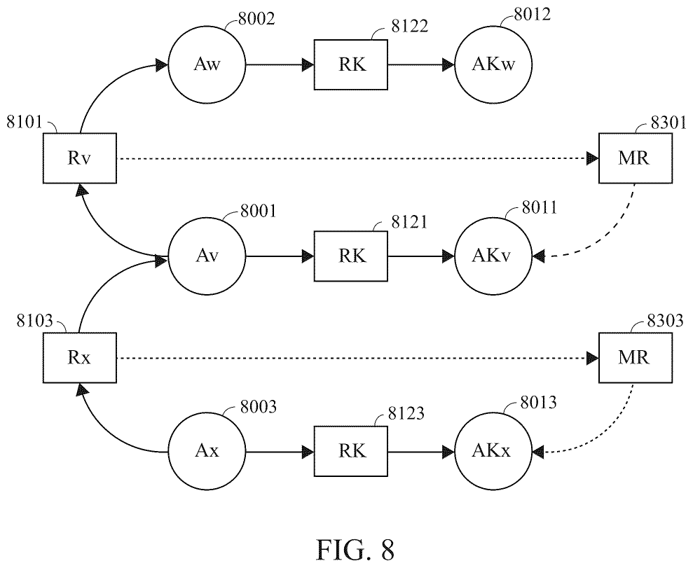

FIG. 7 illustrates inverse relations in an ARB system. A first A 7003 is related to a B 7004 by Rx 7103. This implies an inverse relationship of B 7004 relating to A 7003 by ′Rx 7203. The ′Rx 7203 is the logical inverse of Rx 7103, for example parent-child/child-parent or movie-role/role-movie. The B 7004 is also related to C 7005 by Ry 7104 and an implied inverse Ry 7204. The implied relations are optionally written to a CRSM, or optionally programmatically derived from the explicit relationships.

In one embodiment, each relationship identifier number shares a mathematical relationship to its inverse relationship's identifier number. Optionally, the inverse relationship identifier number is plus or minus X of the relationship identifier number. Alternatively, the inverse relationship identifier number is multiplied or divided by X (where X may be negative) of the relationship identifier number. Alternatively, the inverse relationship identifier flips one bit from the identifier binary. A mathematical relationship between relations allows the system to quickly calculate the inverse of any given relationship identifier. In one embodiment, a first relationship is given a lower even number identifier and its inverse relationship's identifier is one greater, giving it a higher odd number; thus an inverse relation can be calculated as:

$$\$ INVERSE = ( \$ RID \% 2 ) ? ( \$ RID - 1 ) : ( \$ RID + 1 ) ;$$

In one embodiment, a first user has permission to add an Rx 7103 relationship to the A 7003, but the system does not show the ′Rx 7203 relationship for the B 7004. This allows the first user to have permissions to modify data related to the A 7003 element, but not the B 7004 element. Optionally, a second user is permitted to add relationships to the B 7004 element, but not the A 7003 element. Optionally, the second user is presented with a message to accept or reject an ′Rx 7203 according to a Rx 7103. For example, the second user is presented with a message such as, “FirstUser has added this role to the movie Citizen Kane, would you like to add Citizen Kane as the movie in this role?”

In one graph theory interpretation of this paradigm, each A represents a node and each R represents an edge. Each unique R identifier represents a directed graph. And for each R identifier, there is a reverse directed graph ′R. The database as a whole represents a set of directed R graphs for a set of A nodes.

FIG. 8 illustrates an ARB paradigm with business logic using kinds and meta relationships. The Av 8001 is related to the Aw 8002 by Rv 8101. The Av 8001 is also inversely related to Ax 8003 by Rx 8103. The Av 8001 is also related to AKv 8011 by RK 8121. The Aw 8002 is also related to AKw 8012 by RK 8122. The Ax 8003 is also related to AKx 8013 by RK 8123. The Rv 8101 is related to the AKv 8011 by a first meta relationship MR 8301. The Rx 8103 is related to the AKx 8013 by a second meta relationship MR 8303. For clarity, this figure omits the implied inverse relationships. Here, AKv represents a specific type of A termed a kind and RK represents a specific relationship for designating kind. Here kind is akin to type or category or class, where analogous As are related to the same kind. In one embodiment, a kind is a common noun such as person, actor, movie, character, species, color, digital camera, retailer, verb, government agency, or company. For example, both Citizen Kane and Ferris Bueller's Day Off are both related to the kind movie. Optionally, one A is related it to multiple kinds. In one embodiment, each kind itself is an A related to a specified kind A with a specific identifier such as 123. In one embodiment, the RK has a specific identifier such as 456. Meta relationships (8301 and 8303) are used to enforce logic and data integrity. In one embodiment, the meta relationship allows/prevents an A of a certain kind to have certain relationships. For example, the meta relationship allows a “movie-role relation” to related to an A which is related to a movie kind, while preventing non-movies from having this relationship, through programmatic logic. Enforcing such selective relationships prevents erroneous relationships to be made.

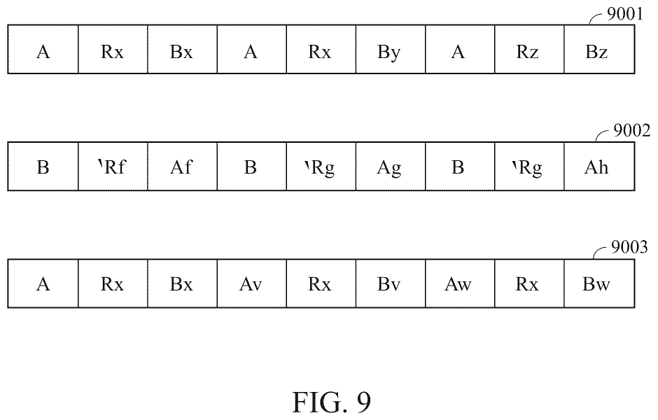

FIG. 9 illustrates one embodiment of a computer-readable storage medium (CRSM) efficiently storing ARB data.

Block 9001 illustrates a CRSM storing ARB data grouped by A value. Each cell is a fixed length, for example, each cell is 8 bytes forming a 32 byte ARB row. The rows are stored sequentially on the medium without needing structuring data or dividers.

Block 9002 illustrates a CRSM storing ARB data grouped by B value. This is a duplicate set of data rearranged for the inverse relation such that the B values are in the A position. Upon manipulating the primary ARB meme, this duplicate meme is similarly manipulated. In one embodiment, Bs in 9002 are grouped with As of equivalent value in 9001.

Block 9003 illustrates a CRSM storing ARB data grouped by R value.

In one embodiment, rows are grouped by the indexed identifier prefix in Huffman coding. In another embodiment, row identifiers are indexed in a skiplist. In another embodiment, row identifiers are indexed using a hash index. In another embodiment, row identifiers are indexed using a B-tree or variant thereof. In another embodiment, row identifiers are indexed using an LSM tree. In another embodiment, rows are indexed and/or grouped using an R-tree. Optionally row placement on the CRSM corresponds to the index.

In one embodiment, rows are indexed to a definite A value such that writing the A value in each row is redundant, and thus the A cell is omitted for each row. In one embodiment, the set of rows where A=$AID are distributed across a plurality of groups and at least one group has empty rows to allow for new A=$AID memes to be quickly written without rearranging groups of data on the CRSM.

In one embodiment, the dataset is stored on multiple CRSMs connected by computer network.

Optionally, each row includes additional meta data such as a row identifier or a created/modified timestamp.

Optionally, each row includes a Q cell, which is optionally a floating-point number. In one embodiment Q=true is given a specific numeric value (such as 1 or 0.00001) so it may be stored in the same format at numeric Qs.

Groups may also be referred to as “pages” or “blocks” or “shards.”

One embodiment is optimized for querying for all memes associated with one identifier $AID, analogous to the SQL query: SELECT*FROM ‘ARB’ WHERE ‘A’=$AID OR ‘B’=$AID;.

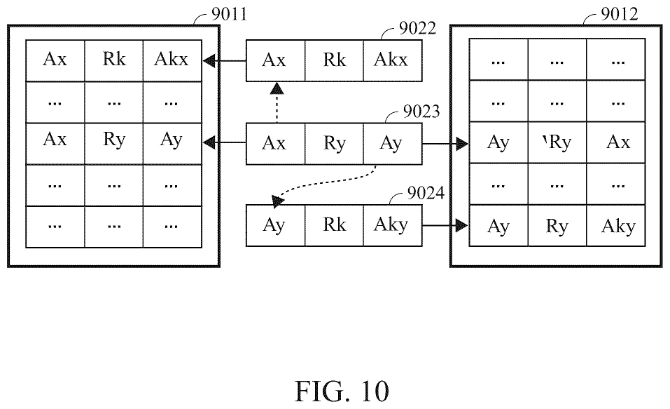

FIG. 10 illustrates one embodiment of ARB data sharding. A shard is a dataset written to at least one location on at least one computer-readable storage media (CRSM). Ideally, sharding data decreases read time and/or decreases the load on one CRSM. Optionally, multiple shards are stored on one CRSM. Optionally, one shard is stored on multiple CRSMs. The left column represents a first shard 9011. The right column represents a second shard 9012. The data in the center (9022, 9023, 9024) represents ARB data. At block 9022, a first row indicates Ax is related to a first kind Akx by relation Rk. At block 9023, a second row indicates Ax is related to Ay by relation Ry. At block 9024, a third row indicates Ay is related to a kind Aky by relation Rk. Rows are assigned a shard by inputting the associated kind into a sharding function. The sharding function is a deterministic mathematical function that receives a large A identifier input and returns a smaller shard identifier output. Preferably, the number of possible sharding function outputs equals the number of shards in the system. Optionally the shard function comprises a hash function such as MD5 or SHA256, or optionally the shard function comprises an arithmetic function such as division or modulus. For example, the shard function performs a modulus 10 operation in order to select one of 10 possible shards; so an A identifier of 12345 would be assigned the shard identified by 5. The first row 9022 is directly related to kind Akx, and kind Akx is assigned to the first shard 9011. To assign a shard for the second row 9023, programmatic logic finds the kind associated with the A identifier Ax. The second row's 9023 A identifier equals the first row's A identifier, which is related to the kind Akx. Thus, the second row 9023 is also assigned to the first shard 9011. All data with the A identifier Ax is stored on one shard for optimal reading. This process is repeated for the B identifier so that all data for a given identifier (in the A and B position) is stored in one shard. Optionally, an ARB row is stored in an inverted form such as: the B identifier in the A position, the inverted R identifier in the R position, and the A identifier in the B position. In one embodiment, the ARB row and inverted ARB row are both stored, optionally on the same or different shards.

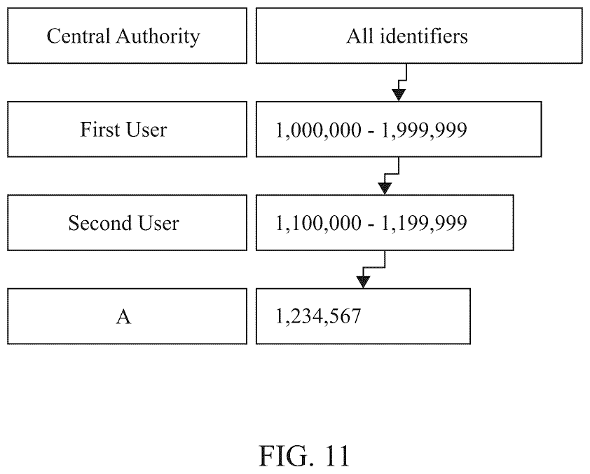

FIG. 11 illustrates an identifier assignment scheme in a distributed embodiment. Typically, each A element has a unique identifier. To avoid identifier conflicts, wherein two users independently identify the same identifier to two distinct A elements, a central authority assigns identifiers to users. Users optionally subassign identifiers to other users. In one example, a first user sends a request to the central authority asking for one million identifiers; the central authority responds with a range of identifiers such as 1,000,000 through 1,999,999; the first user then subassigns the range 1,100,000 through 1,199,999 to a second user; the second user then identifies the identifier 1,234,567 to a given A element. In one embodiment, when a third user queries the central authority as to who owns the identifier 1,234,567, then the central authority replies with an indicator associated with the second user as the first user had previously notified the central authority of the subassignment. Alternatively, the central authority replies with an indicator associated with the first user, who when queried by the third user, replies with an indicator associated with the second user. In one embodiment, a record of identifier assignments is publicly available on a blockchain. Optionally, the central authority cryptographically signs a message assigning identifiers to a user's indicator. Optionally, the indicator is itself an identifier or is optionally a blockchain address. In one embodiment, the identifiers are requested and assigned via API calls to servers operated by the central authority. Optionally, the central authority assigns a sequential range of identifiers or optionally a single identifier. This scheme does allow for two different users to identify different identifiers to the same conceptual A element. While redundant, this prevents one user from adding unauthorized relationships to another user's data. Optionally, two different identifiers for the same conceptual A element are merged such that one identifier effectively replaces the other. Optionally, a new ARB is added wherein A is the unused identifier, R signifies a merger, and B is the used identifier; this relationship can be used to redirect requests from the unused identifier to the used identifier. The central authority keeps a record of identifiers assigned out and the user keeps a record of identifiers to which it was assigned.

Optionally, identifiers are assigned according to a modulus, for example a user is assigned identifiers where X>=ID % Z>=Y.

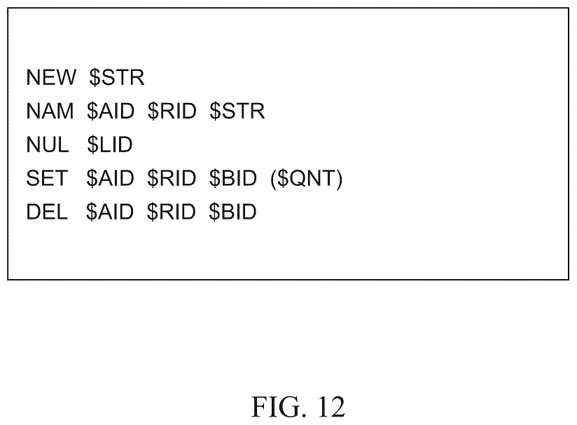

FIG. 12 represents one embodiment of API calls used for manipulating data. The exact embodiment of these commands is arbitrary. These commands are optionally formatted in JSON, YAML, HTTP query, REST, or other structured data formats. In one embodiment, these represent messages written to a blockchain.

NEW $STR
NAM @AID $RID $STR
NUL @AID $RID $STR
DAT @AID $RID $BID ($QNT)
DEL @AID $RID $BID

Here $STR represents a string name associated with an A. The $AID $RID and $BID are associated with an A, R, and B identifiers respectively. The NEW command selects and unused identifier for @AID, sets a string as the primary name for @AID, and outputs @AID. The NAM (add name) command associates additional string names with an @AID where the $RID describes the type of name (e.g. formal, informal, long, short, English, Japanese, etc.). The NUL (nullify name) command deletes a name. Alternatively, NAM returns a $LID identifier which is passed to NUL. The DAT (data) command adds an ARB relationship. The DEL command removes an ARB relationship. Further optional commands may be added for convenience, such as a command to wipe all data associated with an identifier, or a command to merge two identifiers by changing all values of a first identifier into a second identifier. Preferably, each @AID $RID $BID is unique as having duplicate ARB relationships typically does not provide additional information. Optionally, each ARB is given a $DID identifier. The optional $QNT value is a real number quantity of $BID when $BID represents a unit. For example, the @AID value represents light, the $RID value represents speed, the $BID value represents the unit meters per second and the $QNT value is 299792458.

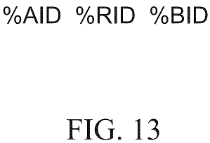

FIG. 13 a illustrates one notation of an ARB logic system. This notation is optionally interpreted by a computer program, executed as a scripting language, transcoded into a programming language, or compiled as executable code. This format optionally expresses meta relationships described above.

| AID | RID | BID | QNT |
|---|---|---|---|
| USRE | KIND | USER | |
| USRF | BAL | UNIT | 123 |
| USRT | KIND | USER | |
| USRT | BAL | UNIT | 456 |
| TRN | KIND | TRNS | |
| TRN | UTO | USRT | |
| TRN | UFRM | USRE | |
| TRN | AMT | UNIT | 99 |
| %AID | KIND | TRNS | |
| @AID | AMT | UNIT | %AMT |
| @AID | UFRM | %USRE | |
| @USRF | BAL | UNIT | %BALF |
| @BALF | #EALB | @AMT | |
| @BALF | #LESS | @AMT | |
| @USRF | BAL | UNIT | @BALF |
| @AID | UTO | %USRT | |
| @USRT | BAL | UNIT | %BALT |
| @BALT | #MORE | @AMT | |
| @USRT | BAL | UNIT | @BALT |

Rows without symbols or with only @ symbols store an ARB triplet, optionally short-term or long-term depending on the embodiment. Rows containing one or more % symbols read matching ARB triplets from storage and set the % variable to the read value(s) from that column, where the value may be one or more identifiers (typically for A, R, and B) or decimal numbers (typically for QNT). The value of a variable is later accessed by replacing the % with an @, so a variable set with % AMT is later read with @AMT. Rows containing # in the R column perform a math, logic, and/or programmatic function as named. Certain functions alter A according to QNT, for example #LESS performs subtraction as A−=QNT and # MORE performs addition as A+=QNT. Other functions perform a comparison of A and B and error if true/false; for example, # EALB (error if A less than B) evaluates A<B and errors if true.

The above code creates a TRN (transfer) where USRF (user-from) transfers 99 UNITs to USRT (user-to). The system checks that USRF has a BAL (balance) greater than the amount transferred. The system deducts the amount transferred from USRF's BAL and credits the amount transfers to USRT's BAL. For illustration, the logic is shown here below the TRNS, however typically the logic would be stored above the TRNS and triggered upon adding a new TRNS.

In another example:

| AID | RID | BID |
|---|---|---|
| BRAND | FLD | PROD |
| WDGT | KIND | PROD |
| WDGT | BRAND | MYCO |
| %AID | %RID | %BID |
| @AID | KIND | %KND |
| @RID | %FLD | @KND |
| @FLD | #EAXB | FLD |

This code enforces data typing such that only certain kinds can have certain relations. The first line defines BRAND (product brand) as a FLD (field) of PROD (product). The second line defines WDGT (widget) as a KIND of PROD. The third line sets WDGT's BRAND as MYCO. The next lines will enforce that AID=WDGT is appropriate for RID=BRAND. The fourth line matches any ARB and sets the % AID, % RID, and % BID variables accordingly. The fifth line looks up the KINDs related to @AID, and sets % KND as an array of matching identifiers. The sixth line looks up matching @RID, $FLD, @KND triples and sets % FLD to the RIDs. The seventh line errors if @FLD does not contain FLD. In this case, WDGT-BRAND-MYCO matches to WDGT-KND-PROD which matches to BRAND-FLD-PROD and therefore does not error.

The above logic expressed in pseudocode:

```
list($AID, $RID, $BID) = get(*, *, *);
$KND = search($AID, KIND, *);
foreach ($KND as $kid) {
  $FLD = get($RID, *, $kid);
  if ($FLD==FLD) return true;
}
exit(‘ERROR’);
```

In one embodiment, the lines containing logic are stored as ARB triplets with specific kinds indicating their functions.

In one embodiment, this technique is used in a Hyperpiler (U.S. Pat. No. 10,942,709 which is hereby incorporated by reference in its entirety) wherein the ARB data comprises the specification entities and the logic comprises the ruleset. Optionally, Hyperpiler segments are stored as strings associated with identifiers.

In certain embodiments, additional columns are added. In one embodiment, a column holds a number representing analogous to weight in a neural network. In another embodiment, a column further describes QNT such as equals, greater than, or less than.

In one embodiment, the $ @ symbols are omitted. Standard AID and BID identifiers are integers. The use of A-Z characters denotes a variable. The first use of a variable denotes “set” and later uses denote “read.”

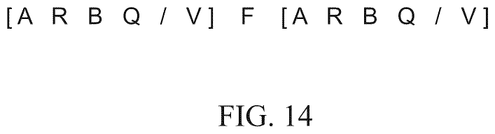

FIG. 14 illustrates an alternate notation of an ARB logic system. This notation is optionally interpreted by a computer program, executed as a scripting language, transcoded into a programming language, or compiled as executable code. This format optionally expresses meta relationships described above. Those skilled in the art will recognize this code may be embodied in many equivalent forms and the form below is but one illustrative embodiment. Further, those skilled in the art will recognize the precise machine execution of this code will vary from system to system and may be optimized for various factors.

[A R B Q/V] F [A R B Q/V] A query is wrapped in brackets. The first four terms are the query A, R, B, and Q values. Each of those values is optionally a wildcard character, such as a period. Missing ending terms are typically considered wildcards. The next term is the operator, wherein a forward slash indicates to output the value set by last term. The last term is the output term, which is A, R, B, or Q. The F is a function that compares or operates on the two queries. Comparison functions—such as equal to, greater than, less than, array comparisons, or similar—evaluate to true/false typically throw an error on false. Mathematical functions—including add, subtract, multiply, divide, and similar—modify the left query's Q according to the right query's Q. Further, a write function adds a new specified right query meme foreach returned left query meme.

The system searches the data for memes matching the query and returns one or more values of the output term. The SQL equivalent of the query [A R B Q/V] is below. Typically, wildcard values would be omitted from the where clause. SELECT V FROM ‘dat’ WHERE aid=A AND rid=R AND bid=B AND qnt=Q;

In a special case, a query specifying only one term, which is also the output term, returns that term as a constant with no actual data querying necessary; for example [ . . . 0/Q] returns zero. Typically, this is done for units or quantities.

Queries are optionally nested: [[A R . . . /B] R B/B]

Here the internal query returns a B value which used as the A in the external query. Recurring use of the same nested query in one statement is optionally be treated as a variable, wherein the output value is stored in memory and does not need to be required for the same statement.

Similar rules to those described above are embodied in this format as:

[[[. KIND TRNS / A] USRF / B] BAL / Q] >= [[. KIND TRNS / A] AMT / Q]
[[[. KIND TRNS / A] USRF / B] BAL / Q] − [[. KIND TRNS / A] AMT / Q]
[[[. KIND TRNS / A] USRT / B] BAL / Q] + [[. KIND TRNS / A] AMT / Q]
[. BAL / Q] >= [... 0 / Q]
[. BAL / B] = [.. UNIT / B]
[. KIND USER / A] W [[. KIND USER / A] BAL UNIT 0]

The first line requires that balance of the user-from in a transfer must be greater or equal to the user's balance. The second line decreases the user-from's balance. The third line increases the user-to's balance. The fourth line requires that a user's balance must be greater or equal to zero. The fifth requires the balance is denominated in UNITs. The sixth line creates a balance of zero for a user upon the creation of that user.

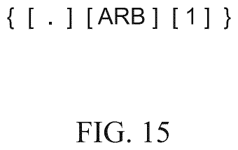

FIG. 15 Illustrates an alternate one notation of an ARB logic system. This notation is optionally interpreted by a computer program, executed as a scripting language, transcoded into a programming language, or compiled as executable code. This format optionally expresses meta relationships described above. Those skilled in the art will recognize this code may be embodied in many equivalent forms and the form below is but one illustrative embodiment. Further, those skilled in the art will recognize the precise machine execution of this code will vary from system to system and may be optimized for various factors.

Memes specify relations between elements.

[A R B] A meme stating that some A has some relation R to some B.

[A R B Q] The property R of some A is Q quantity of B units. Q is default NULL or a specified real number.

[[A1=w] [R1=x] [B1=y] [Q1=z]] Alternate syntax.

Sets contain memes.

[A R.] The set of memes having some A with some relation R to any B. Dot and undefined are wildcards.

[ . . . (>0)] The set of memes having a quantity greater than zero.

Sequences manipulate sets of memes.

{[Ax Rx Bx Qx] [Ay Ry By Qy]} Sequence. A “for each” loop is applied to each set, left to right. Ends on empty set.

{[ . . . ] [A1 R1 B1 Q1] [A2 R2 B2 Q2]} Left values populate numbered variables to the right.

{[ . . . ] [A . . . ] [A . . . ]} An unnumbered variable is populated from previous set.

{(A1=w) (R1=x) (B1=y) (Q1>=z) (A2=B1)} Alternate syntax. Variables are automatically grouped into queries.

{[ . . . ] [B1 (′R1) A1 Q1]} Every relation has an implied inverse relation (′R).

{[.balance.] [.recipient A1] [A2 amount.] [A1 R1 B1 (+Q3)]} Example of accumulating transactions into a balance.

{[+R ‘New element’] [A1 . . . ]} Create a new named element, return the element's ID.

{Rx Ry Rz}=={[.Rx.] [B Ry.] [A1 Rz B2]} The left term is an abbreviation for the defined “logic box.”

Commands interact with sets

{[.... >]} Output all memes in the set (default).
{[.... 0]} The set must contain zero memes, or error.
{[.... 1]} The set must contain exactly one meme, or error.
{[.... 2]} The set must contain at least one meme, or error.
{[.... <]} Write all memes in the set.
{[.... !]} Delete/falsify all memes in the set.
{[.... +]} Sum all Q's in the set.
{[.... *]} Multiply all Q's in the set.
{[.... @]} Count memes in set.
{[....][@]} Alternate syntax.

Unities compare sequences.

<<{X}{Y}{Z}>> Given the first sequence, all following sequences are equivalent. An empty first sequence means always equivalent. Equivalent sequences are listed by preference.

<<{ }{[.]}{[. .]}{[. . .]}{[. . . .]}{[.][.]}>> Dots are equivalate to undefined

<<{[W∈R][X∈R]}{[W+X]}{[X+W]}>> Commutative property of addition

<<{[X!=L][Y!=M][Z!=N]}{[X Y Z]}{[L M N][X Y Z]}>> Non-sequitur terms Special relations.

<<{[Rx=(′Rx)]}{Rx Rx}{[.Rx.][B1 Rx A1]}>> Rx is mutual.

{Rx Ry (′Ry)} Rx is a sibling relation with respect to Ry.

One sequence optionally comprises a breadth-first search (BFS). BFS is an algorithm for searching a tree data structure for a node that satisfies a given property. It starts at the tree root and explores all nodes at the present depth prior to moving on to the nodes at the next depth level.

Another sequence optionally comprises a depth-first search (DFS). DFS is an algorithm for traversing or searching tree or graph data structures. The algorithm starts at the root node (selecting some arbitrary node as the root node in the case of a graph) and explores as far as possible along each branch before backtracking.

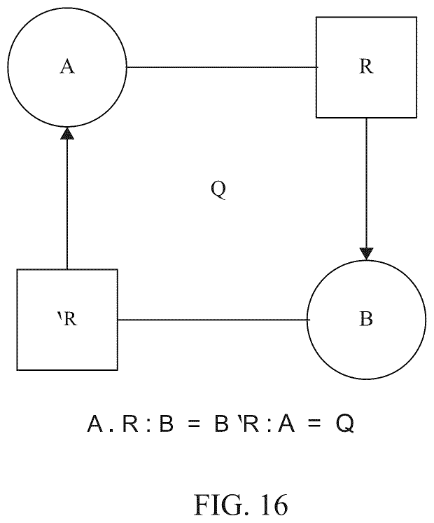

FIG. 16 Illustrates an alternate notation of an ARB logic system. This notation is optionally interpreted by a computer program, executed as a scripting language, transcoded into a programming language, or compiled as executable code. This format optionally expresses meta relationships described above. Those skilled in the art will recognize this code may be embodied in many equivalent forms and the form below is but one illustrative embodiment. Further, those skilled in the art will recognize the precise machine execution of this code will vary from system to system and may be optimized for various factors.

(R(A,B)=Q) This is a memetic relation in conventional notation. A function R takes two identifiers as inputs and outputs null, false, true, or a real number.

$$Q := \{ null , false , true , real number \} .$$

(R(A,B)=null) Relation is unknown.

(R(A,B)=true) A is known to be related by R to B.

(R(A,B)=false) A is known NOT to be related by R to B.

(R(A,B)=real number) The property R of A is the quantity Q of B units.

(R(A,B)=′R(B,A)=Q) Every relation has an inverse relation ′R where the A and B identifiers are swapped.

(R(A,B)=A.R:B) This is memetic notation. It will be more convenient than conventional notation as we proceed.

(B′R:A=Q) Memetic notation for an inverse relation.

(kind(alice,user)=true==alice.kind:user=true==alice.kind:user==alice kind user==user ′kind alice) Example meme stating that Alice is a kind of user. For simple statements, the punctuation is assumed.

(balance(alice,usd)=99==alice.balance:usd=99==alice balance usd 99==usd ′balance alice 99) Example meme with a numeric quantity stating that Alice has a balance of $99.

(Ax.Rx:Bx>Qx & Ax.Ry:By>Qy@cnt?=0) Each expression in the statement has a special function. Certain expressions return sets and forward arrays, where the array is one place value from each set (e.g. every A from the set). In one embodiment, an expression causes data to be read from a lower-speed CRSM and an array of sets and/or an array of values to be written to a higher speed CRSM according to the context in a memetic statement.

(A) If specified, retrieves the set of all memes with this A. If omitted, the starting set is the set of all memes. Forwards an array comprising the As. Only used at the start of a statement. A set of memes all having the same A value is termed an A-set.

(.R) Retrieves the set of all memes with this R and an A equal to any value from the previous forwarded array. Forwards an array comprising the Bs. The output set may be larger than the input set.

(′R) Retrieves the set of all memes with this R and an B equal to any value from the previous forwarded array. Forwards an array comprising the As. The output set may be larger than the input set.

(:B) Filters the previous set to only those memes with this B. Forwards an array of Qs. Only used at the end of a statement. A set of memes all having the same B value is termed an B-set.

(?=, >, <, >=, <=,!=) Quantity operators filter the previous set to only those memes with satisfying Qs.

(+, −, *, /) Arithmetic operators receive the array of Qs by default.

(+=, −=, *=, /=) Arithmetic-update operators receive the array of Qs by default and update the Q value in the respective meme.

(&) The conjunction set operator merges two sets into one set where every A appears in both sets. Memes with As in only one set are excluded. It is optionally processed in parallel on a computing device.

(|) The disjunction set operator merges all memes from two sets into one set. The (;) semicolon defaults to (|) behavior in appropriate cases. It is optionally processed in parallel on a computing device.

(˜) The non-conjunction operator merges two sets into one set where every A appears in only one set, but not both. It is effectively both XOR and NAND. It is optionally processed in parallel on a computing device.

(@cnt) The counter operator counts the number of memes in the previous set. The counter operator may be paired with a quantity operator such as (@cnt?=0), which emits an error if it evaluates to false. Likewise, @min, @max, @avg, @sum, @prod perform their respective aggregate functions.

((A.Rx|A.Ry)==A.Rx,Ry) A disjunction of two relations on one A returns a set with both relations and is equivalent to SELECT Rx, Ry in SQL. This sequence is simplified to a comma for brevity. It is optionally processed in parallel on a computing device.

(alice.parent.brother:bob=true) Rs may be chained. Here, Alice has some unnamed parent who has a brother Bob.

(bob.′brother.′parent:alice=true) or (bob′brother′parent:alice=true) Inverted Rs chain A-A or B-B or A-B. The dot is assumed before an apostrophe.

(.uncle==.parent.brother) A relation may be defined as a chain of other relations.

(′uncle==′brother′parent) The inverse of a chain is the relations inversed and reversed.

(.brother==(.sibling & B.gender:male)) A relation between A and B may imply a tangential relation to a C. Here, .brother implies that the B is male. B is underlined to signify the literal letter B is used in the definition.

(′brother==(′sibling & male ′gender:A)==(.sibling & A.gender:male)==(.sibling & .gender:male)) When A or B is used in the definition, the inverse is further “abversed” to swap the defined A and B. Typically, A is omittable from the definition.

(.speed:mps==.distance:m/.time:s) A relation may be defined as a mathematical operation between other relations. Here, for A where A.distance:m is a number and A.time:s is a number, create a new meme A.speed:mps equal to the quotient of the numbers of other two memes.

(camera′kind.price*=0.8) Here, all camera price quantities in all units are reduced by 20%.

(alice kind user; alice balance usd 99; user′kind.balance:usd<0@cnt?=0) Here, a user's balance cannot fall below zero.

(.kind:camera &!.kind:phone & (.price:usd <1000|.resolution:megapixels>20)) Here, the query finds a set where each meme belongs to a camera, or a phone, but not an item that is both camera and phone, that is priced less than $1000 or has more than 20 megapixel resolution. For each satisfying A, the output set includes the A.kind, A.price:usd, and A.resolution memes.

(Af==(Af.Rx:Bx=Qx & Af.Ry:By=Qy & . . . )) An identifier is defined as the conjunction of all relations.

((Ag<=Af)==(Ag.Rx:Bx=Qx & Ag.Ry:By=Qy & . . . )) The analog operator that applies the relations from the statement on the right to the statement on the left. Here Ag receives all of Af's relations.

((Ag=!Q<=Af)==(Ag.Rx:Bx=!Qx & Ag.Ry:By=!Qy & . . . )) Here, the (!Q) on the right applies “not” to all Q's in Af's relations, making Ag is the opposite of Af.

(Ag:Bg<=Af:Bf) Here, all relations between Af and Bf are applied between Ag and Bg.

(.hypotenuse:num==(.xcoord:num\hat{ }2+.ycoord:num\hat{ }2)\hat{ }0.5; alice.xcoord:num=5; alice.ycoord:num=10; bob.xcoord:num=17; bob.ycoord:num=120; ((distance<=alice)−=bob).hypotenuse) Here, an example of a relation calculating the distance between two objects.

($hypotenuse==(.first:A & .second:B & .length:num=((A.xcoord−B.xcoord)\hat{ }2+(A.ycoord−B.ycoord)\hat{ }2)\hat{ }0.5); (alice|bob)$hypotenuse; alice$hypotenuse:bob)) The matrix operator takes a set of disjunctive A-sets and performs the described relations on each permutation. The resulting new temporary memes are given A identifiers distinguishing them as temporary; for example, permanent identifiers are positive and temporary identifiers are negative. If the program instructs the device to permanently store the temporary memes, then the temporary identifiers are swapped for permanent identifiers. Here, an example of a process calculating the distance between each A-set in the disjunctive A-sets of Alice and Bob.

(A::B) Does a search for all relations between A and B. Optionally, depth is limited. Optionally, performs depth first search, breadth first search, variant, or combination thereof.

(bob.human.bob=true) Relations are optionally reflexive. Reflexive relations are inherently symmetrical. This reads, “Bob is a human.”

(A.is:B=A.B@cnt>0) The existential relation is true/false if A has any B relation. Note that the B transposes to the R position on the right.

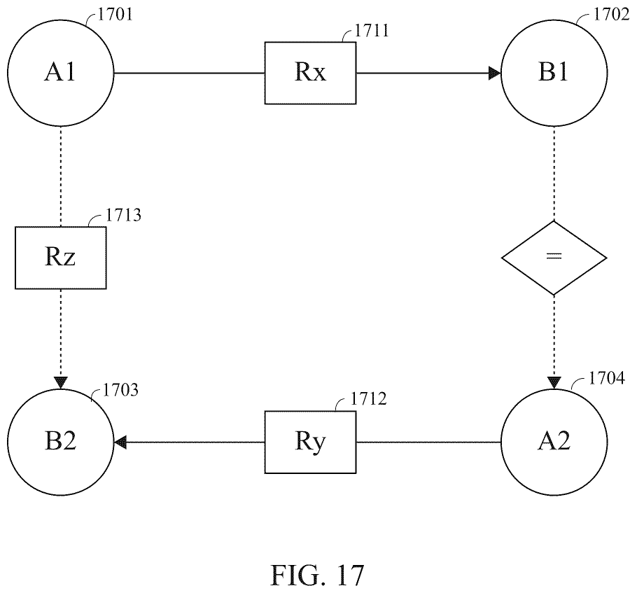

FIG. 17 Illustrates a logic box. The logic box sequence comprises three R values: Rx 1711, Ry 1712, and Rz 1713. The data set comprises A1 1701 related by Rx 1711 to B1 1702; and A2 1703 related by Ry 1712 to B2 1704. The B1 1702 and A2 1704 have the same identifier value (B1=A2), representing the same idea. The logic box sequence finds a first set of memes related by Rx 1711, wherein a first meme in the first set comprises A1 1701, Rx 1711, and B1 1702. The logic box sequence then finds a second set of memes with an unknown B related by Ry 1712 to A2 1704, wherein B1=A2. The logic box sequence then creates a third set of memes, with one meme comprising A1 1701 related by Rz 1713 to B2 1703. Optionally, any of the A and B values are inverted by using an inverted R value (′R). In one embodiment, this is transcribed as {[.Rx.][B1 Ry.][A1 Rz B2]} or in shorthand {Rx Ry Rz}.

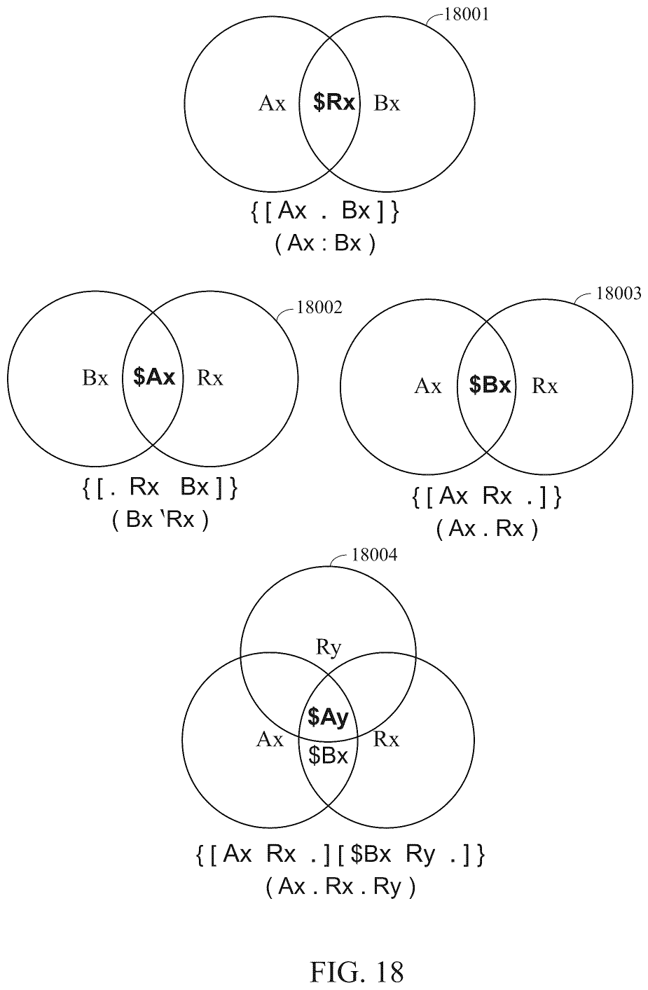

FIG. 18 Illustrates queries in terms of sets of As, Rs, and Bs. Each query returns a set of memes, the figure illustrates the unknown place value which the query produces. At block 18001, a query with known A=Ax and B=Bx values produces a set with unknown R=$Rx values. At block 18002, a query with known B=Bx and R=Rx values produces a set with unknown A=$Ax values. At block 18003, a query with known A=Ax and R=Rx values produces a set with unknown B=Bx values. Queries are optionally chained as shown in block 18004, wherein a first query with a known A=Ax and R=Rx value produces unknown B=Bx values and those now-known Bx values are paired with a known R=Ry value to find a set with unknown A=$Ay values.

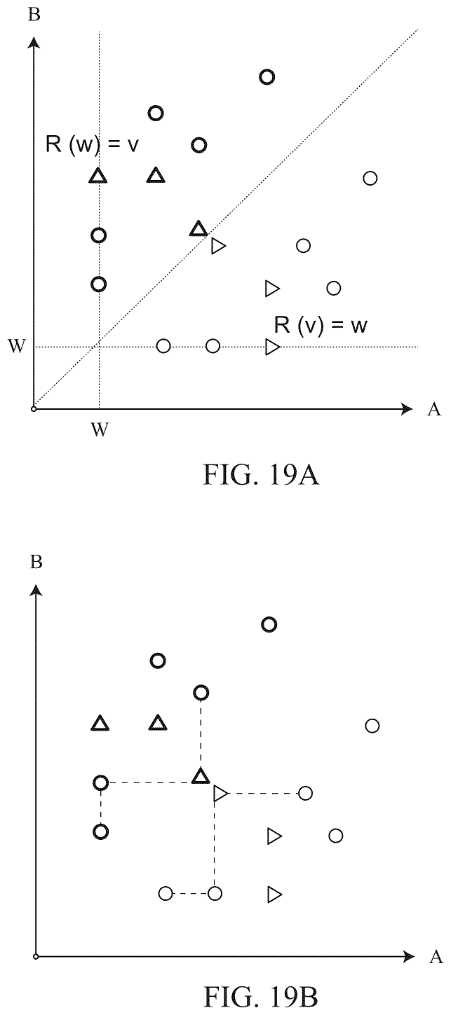

FIG. 19A Illustrates an ARB scheme on a cartesian plane. The vertical axis represents the B identifier, the horizontal axis represents the A identifier. A first relation function R(A)=B is plotted with circles. A second relationship function Rt(A)=B is plotted with triangles. Bold shapes represent the original relationship, thin shapes represent inverse relationships ′R(A)=B and ′Rt(A)=B. The graph is semi-symmetric across the line A=B due to the inverse relations. A horizontal line for B=w and a vertical line for A=w is shown. All dots on a vertical or horizontal line share a logical relationship as they all relate to the same identifier. The relation functions are discontinuous. Here, each coordinate output for a relation function is termed a node.

In one embodiment, ARB data is stored on a CRSM in an (A,B) coordinate system where the cell at a given coordinate stores one or more R identifiers for the ARB relationship.

FIG. 19B Illustrates a logical sequence on an ARB scheme on a cartesian plane. A logical sequence follows horizontal and vertical lines between nodes. Here, these lines are termed edges. In this example, the same logical sequence is drawn twice, once for the primary relationships and once for the inverse relationships. An efficient logical sequence alternates between horizontal and vertical movements. Two horizontal or two vertical edges in succession does not reveal new information.

A logical sequence may have a pseudo-diagonal edge by inverting a relationship. Such an inversion could be depicted with only vertical/horizontal edges and inverting the relationship does not change any logic or knowledge. However, in certain embodiments, it is useful to use an inverted relationship in storing sequences or retrieving data from a CRSM. A pseudo-diagonal edge that starts at (a,b) will end at either (b,x) or (x,a), where x may equal a or b, such that the ending coordinate shares at least one value from the starting coordinate on the opposing axis.

In the example graph shown, circles represent siblings and triangles represent parents. The edge traces an aunt/uncle relationship which can be verbalized as “my sibling's parent's sibling is my aunt/uncle.”

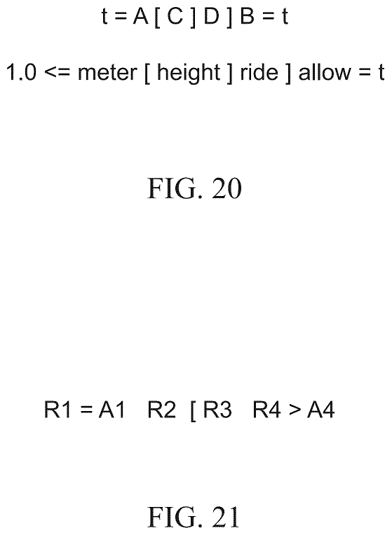

FIG. 20 illustrates an alternate logic notation. In this notation, the R relation is divided into two types: C for conditional relations and D for declarative relations. Typically, Rs in previous figures are declarative. The previous Q quantity has been renamed W has a conditional V counterpart. This notation traverses a knowledge graph using three novel operators: Condition [, Inversion −, and Declaration]; in addition to standard math operators such as: =, !=, <=, >=, >, and <. Collectively, conditions and declarations are called relations and serve as edges between A and B nodes on a graph. The basic syntax states that some thing A has some declared relation D to some other thing B:

$$A ] D ] B = W$$

For example, “Alice's uncle is Bob,” where A=Alice and D=uncle, B=Bob, and W=t (true). This relation is encoded thusly:

$$Alice ] uncle ] Bob = t$$

The W value may indicate true/false or a quantity. Whenever the value is a quantity, the B must be a unit of that quantity. For example, “Alice's height is 1.6 meters” is encoded:

$$Alice ] height ] meter = 1.6$$

Relations may be chained. For example, we know that an uncle is a parent's brother:

$$Alice ] parent ] brother ] Bob = t$$

Logically, for any declared relation, there exists an inverse relation as well. The inverse relation is indicated by a minus sign:

$$A ] D ] B = B ] - D ] A$$

For the example above, Bob's “inverse uncle” is Alice. In English, inverse uncle could be “niece” or “nephew.”

$$Alice ] uncle ] Bob = Bob ] - uncle ] Alice$$

Inverse relation chains are inverted and reversed:

$$Alice ] parent ] brother ] Bob = Bob ] - brother ] - parent ] Alice$$

An incomplete declaration is interpreted as a search query where the missing field is a wildcard:

A is wildcard, returns everyone who has Bob as an uncle:

]uncle]Bob

B is wildcard, returns everyone who is Alice's uncle:

Alice]uncle]

D is wildcard, returns all declared relations between Alice and Bob:

Alice]]Bob

Both Bs are chained wildcards, returns all grandchildren of Cindy:

Cindy]child]child]

In one embodiment, an empty =W is interpreted as the semi-wildcard !=f which returns any value except false.

To search for A values matching two declarations, the space character is used as an AND operator. This query searches for people whose uncle is Bob and whose mother is Cindy:

]uncle]Bob]mother]Cindy

To search for A values that match at least one of multiple declarations, the special =tn (where n is a whole number) value serves as an OR operator. All statements with the same n value are grouped into an OR clause. The query below searches for people whose uncle is Bob and whose mother is Dana or Cindy:

$$] uncle ] Bob ] mother ] Dana = t 1 ] mother ] Cindy = t 1$$

The Condition [ operator encodes logic as “if” or “when.” The Declaration ] operator can be considered “then.” For example, the relation chain of “if A uncle's is B, then A's parent's brother is B” is encoded:

[uncle]parent]brother]

The left side may also encode a quantitative value. For example, “if a person is at least 1 meter tall, then they may ride the rollercoaster” is encoded:

$$1. <= meter [ height ] rideRollercoaster ] allow = t$$

A condition may suggest a relation. For example, any kind of product should have a price in USD greater than or equal to one cent.

$$product [ kind ] price ] usd >= 0.01$$

In one embodiment, this notation is stored in an SQL relational database such as MySQL™ or PostgreSQL. In one scheme, the database stores both declarative memes and conditional-logic memes in the same table:

CREATE TABLE meme (
V DECIMAL /* floating point number like 1.1 */
VE VARCHAR, /* equality operator like < > = */
A VARCHAR, /* A node */
C VARCHAR, /* Condition */
D VARCHAR, /* Declaration */
B VARCHAR, /* B node */
WE VARCHAR, /* equality operator like <= != */
W DECIMAL /* floating point number like −2.7 */
);

Each row is interpreted to produce a meme in the form:

$$V = A [ C ] D ] B = W$$

To store an unconditional statement, the special C= is used. This relation is reflexive such that:

$$A [ is ] D ] B = A [ - is ] D ] B = A ] D ] B$$

So the simple statement Alice]uncle]Bob is be expanded to have the row values V=1 (true) VE=“=” A=Alice C=is D=uncle B=Bob WE=“=” W=1 (true), which produces:

$$t = Alice [ is ] unlcle ] Bob = t$$

Any other C value produces a conditional statement. For example, the row values V=1 VE=“=” A=product C=kind D=price B=usd WE=“>=” W=0.01 form:

$$t = product [ kind ] price ] usd >= 0.01$$

In one embodiment, when parsing this notation, a program stores two arrays on a CRSM. The first operator array represents the condition, declaration, equality, numeric, delimiter, and related operators. The second operand array represents co-indexed identifiers for the specific condition relation, declaration relation, equality relation (e.g. =, >=, <), floating point number, or other operand associated with the operator.

In one embodiment, the two operators and operands arrays are interlaced into one array in the order of operator1, operand1, operator2, operand2, and so forth.

In one embodiment, the operator array and operand array elements are converted to binary numbers, padded with zeroes to a certain bit length, then written to a CRSM. Optionally, a smaller set of operators allows a shorter bit length for each operator, for example, each operator is given 8 bits while each operand is given 32 bits. Optionally, the binary operators and operands are interlaced on a CRSM such that, using the prior example, each pair occupies 40 bits.

In one embodiment, statements are preceded/followed by a delimiter operator such as a semi-colon, (;). The operand co-indexed with the delimiter operator is a floating point or integer value equal to the number of operators in the preceding/following statement.

In one embodiment, all data from the operand array is compressed into the delimiter operand such that only the operand array is necessary. The delimiter operand is a numeric value which can be unpacked into an array of operators. For example, a CRSM contains a mapping of 1234 to t=[ ]>=5, whereby the operands following a delimiter operand of 1234 are each sequentially associated with each of those operators. Or, for example, the delimiter operand is a binary number that is chunked into X bits, each chunk representing an operator.

FIG. 21 illustrates an alternate key-value-like logic notation. Here M is used similarly to B in certain prior notations, where M is a identifier with no external semantic meaning. Those skilled in the art will recognize that various punctuations are arbitrary and the disclosed punctuations are one illustrative example.

A meme is analogous to a relational database row. A meme comprises key-value pairs, separated by spaces, starting with an arbitrary integer M-identifier, and ending with a semicolon: m=123 R1=A1 R2=A2;. R-relations are alphanumeric keys analogous to relational database columns. A-values are integers, decimals, or strings analogous to relational database cell values. A-value strings containing [\hat{ }A-Za-z0-9_] characters are double-quoted =“John \“Jack\” Kennedy”. Comments are prefixed with double forward slashes //.

// Example memes for the Star Wars cast
m=123 actor=“Mark Hamill” role=“Luke Skywalker” movie=“Star Wars” rating=4.5;
m=456 actor=“Harrison Ford” role=“Han Solo” movie=“Star Wars” rating=4.6;
m=789 actor=“Carrie Fisher” role=Leia movie=“Star Wars” rating=4.2;

Search queries are partially specified statements. Empty parts of the statement are wildcards. Empty A-value queries the specified R-relation for any A-value. Empty R-relation queries the specified A-value for any R-relation. Empty R-relation and A-value (=) queries for all pairs in the meme.

// Example query for all movies with Mark Hamill as an actor
actor=“Mark Hamill” movie=;
// Example query for all relations involving Mark Hamill
=“Mark Hamill”;
// Example query for all relations and values from all memes relating to Mark Hamill:
=“Mark Hamill” =;

String A-values use = and != operators. Numeric A-values use standard comparison operators =>, >=, <, <=, and !=. For example: firstName=Joe lastName!=“David-Smith” height>=1.6 width<2 weight!=150;

R-relations may be prefixed with ! for “relation must not equal.”

// Example query for Mark Hamill's non-acting relations
!actor=“Mark Hamill”;
// Which is distinct from an actor who is not Mark Hamill
actor!=“Mark Hamill”;

Analogous to relational database joins, using R1[R2 allows for queries matching multiple memes where the A-value for R1 equals the A-value for R2. Open brackets do not need to be closed.

// Generic example
R1=A1 R2[R3 R4>A4 A5=;
// Example query for all of Mark Hamill's costars
actor=“Mark Hamill” movie[movie actor =;
// Example query for all movies in which both Mark Hamill and Carrie Fisher act together
actor=“Mark Hamill” movie[movie actor=“Carrie Fisher”;
// Example query for anyone who is both an actor and a producer
actor[producer;
// Example query for a second cousin: child's parent's cousin's child
child= parent[cousin parent[child;
// Join any A-Value from the current meme to that A-Value in any another meme
R1=A1 [ R2=A2

Joined queries return one meme with multiple m=M-identifiers. Each R=A belongs to the preceding m=meme. For example: m=123 actor=“Mark Hamill” movie=“Star Wars” m=456 movie=“Star Wars” actor=“Harrison Ford”;

R-relations or A-values may be certain variable symbols. Variables cannot be wrapped in quotes. @ Last matching A-value. % Last matching R-relation. # Current M-identifier. Examples:

// Join two different memes where R1 and R2 have the same A-value (equivalent to R1[R2)
R1= m!=# R2=@;
// Two different R-relations have the same A-value
R1= R2=@;
// The first A-value is the second R-relation
R1= @=A2;
// The first R-relation equals the second A-value
=A1 R2=%;
// The pattern is run twice (redundant)
R1=A1 %=@;

More complex joins are made by specifying m and using the # variable.

m=# is implicit in every R=A pair, which are assumed to belong to the current M-identifier

m!=# joins to any other meme, excluding the current one

m=joins to any meme, including the current one

m=\hat{ }# (shorthand ]) sets m and # to the previous M-identifier, used to unjoin and branch queries.

// Join two different memes where R1 and R2 have the same A-value (equivalent to R1[R2)
R1= m!=# R2=@;
// Join any memes (including the current one) where R1 and R2 have the same A-value
R1= m= R2=@;
// Join two different memes, unjoin, join a third meme (two equivalent statements)
R1[R2] R3[R4;
R1= m!=# R2=@ m=\hat{ }# R3= m!=# R4=@;
// Unjoins may be sequential
R1[R2 R3[R4]] R5=;
R1= m!=# R2=@ R3= m!=# R4=@ m=\hat{ }# m=\hat{ }# R5=;
// Join two different memes on R1=R2, unjoin, then join the first meme to another where R4=R5
R1= m!=# R2=@ R3= m=\hat{ }# R4= m!=# R5=@;
// Query for a meta-meme. R2's A-value is R1's M-identifier
R1=A1 m= R2=#

In one embodiment, memes are stored in a SQL database using a table such as:

CREATE TABLE IF NOT EXISTS meme (r TEXT, alp TEXT, amt DOUBLE PRECISION, m
BIGINT);
CREATE INDEX IF NOT EXISTS meme_m_idx ON meme (m);
CREATE INDEX IF NOT EXISTS meme_amt_idx ON meme (amt) WHERE amt IS NOT NULL;
CREATE INDEX IF NOT EXISTS meme_r_idx ON meme USING HASH ((LOWER(r)));
CREATE INDEX IF NOT EXISTS meme_alp_idx ON meme USING HASH ((LOWER(alp)))
WHERE alp IS NOT NULL;

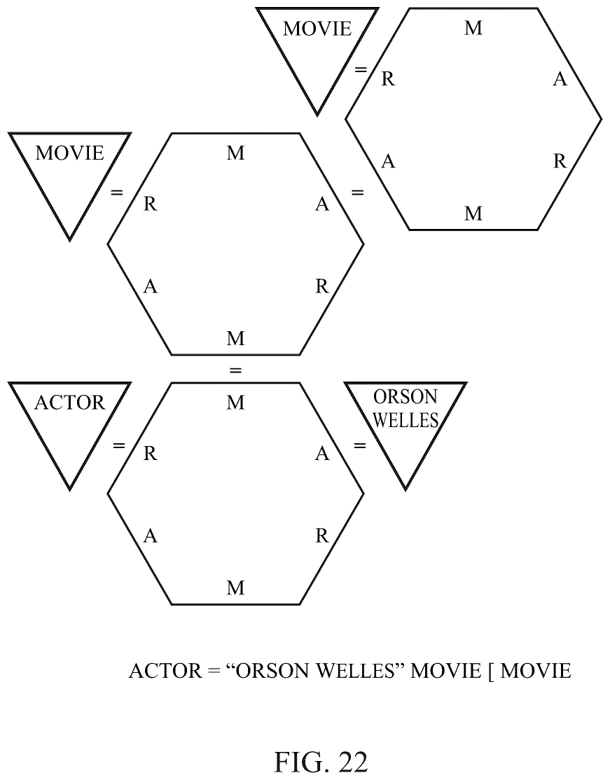

FIG. 22 is a visualization of the prior notation using a vertical stack of regular hexagons arranged bottom-to-top. Each hexagon exposes three inbound edges along its lower half for the M-identifier, R-relation, and A-value; and three outbound edges along its upper half for the same fields, establishing an upward flow of data through the stack. A hexagon represents an R=A binding with either an implicit m=#join or explicit m=x join.

At least one outbound edge of any given hexagon is coupled to at least one inbound edge of the next higher hexagon. Adjacent hexagons may be joined on equality of tokens in any pairing of fields, including R=A, M=R, or A=M, thereby allowing flexible propagation and transformation of identifiers, relations, and values as the sequence ascends. The bottom hexagon, lacking inbound edges, originates the stack, while the top hexagon, lacking outbound edges, terminates it.

Literal constants are denoted by triangular glyphs affixed to the relevant edge of a hexagon. A triangle on a lower edge designates an inbound literal; a triangle on an upper edge designates an outbound literal. In the illustrated example, triangles labeled MOVIE supply literal relation names to lower hexagons, and a triangle labeled ORSON WELLES fixes the A-value emitted by the top hexagon, enabling immediate visual distinction between constants and propagated tokens.

The space between adjacent edges contain the joining comparison operator such as =, !=, >, <, >=, and <=.

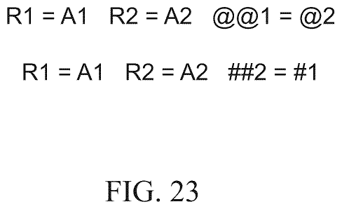

FIG. 23 illustrates an alternate variable system for FIG. 21.

A first novel feature is a bidirectional variable scheme that stores every encountered key list and value list in ordered arrays. The forward index p is the one-based ordinal of the pair in strict left-to-right order. The sigil # p retrieves the A list from an absolute forward position, and the double sigil ## p retrieves the Rs list from that same absolute position; thus #1 references the A list of the first pair, #2 the second pair, and so on. The backward index q counts pairs in reverse from the current pair where q=p₂−p₁. The symbol @ retrieves the A list from a relative backward position, while the doubled symbol @@ retrieves the R list from that same relative position; thus @1 references the immediately preceding pair, @2 the pair before that, and so forth. When a query pair contains exactly one explicit key, the present invention lower-cases that key into a dictionary handle, permitting later pairs to access its captured values with expressions such as # actor:p or @birthyear:q. This mechanism replaces the prior scheme of FIG. 21, which exposed only three single-symbol variables and offered no numeric indexing.

In one embodiment, each meme's ARB triplet stored on a long-term CRSM (such as an SSD). A processor reads a first query term (e.g. “movie=*”) and copies matching triplets from the long-term CRSM to appropriate arrays in a transient working buffer computer-readable storage medium (such as memory) array. The index position assigned to each newly appended entry defines the forward index p, and by counting backward from the current pair the engine derives the backward index q. Variable operators #, ##, @, and @@ then reference these arrays in evaluating subsequent query terms. The processor reads a second query term (“movie=@2”), determines the @2 references the A value two pairs backward, reads that value from the short-term CRSM and reads matching triplets from the long-term CRSM. When the query concludes the transient arrays are discarded, leaving the persisted memes unmodified.

A second novel feature introduces comma-delimited lists on both the key side and the value side of a pair, thereby collapsing what formerly required multiple pairs into one while preserving inclusive OR semantics.

A third novel feature removes the join brackets of FIG. 21 and replaces them with a sugar -> which is shorthand for m!=@m, which counts as one pair. This keeps the ordered variable arrays coherent.

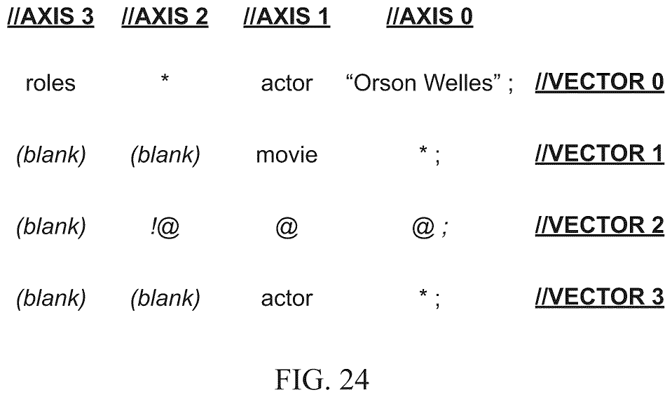

FIG. 24 illustrates an axis-based logic notation which unifies tabular, vector, and graph data semantics within a single positional grammar. Every query term is expressed as a stack of ordered axis constraints, where the syntactic position of a token conveys its structural role. Axis positional encoding reduces run-time schema discovery and join-inference overhead compared to textual keyword approaches such as SQL or SPARQL. Punctuation symbols are exemplary and may vary.

This notation generalizes the 3-axis notation implicit in FIG. 13 to n-axes. Further, this notation consolidates the m=m r=a in FIG. 21 into a 3-axis vector m r a whose implicit axes are 2, 1, 0 respectively. Further, this notation formalizes for n-axes the 2-axis relations depicted in FIG. 19.

In one embodiment, the invention parses a query string into a hierarchical Matrix→Vector→Limit→Data lattice whose coordinates are numeric axes, thereby allowing a single syntax to address tabular (SQL), graph-based (RDF), and vector stores. Datum-separators (commas) enumerate disjunctive data on one axis. Data is paired with a comparison operator to form a limit. Limit-separators (space) enumerate descending conjunctive axis constraints, forming a vector. A vector-separator (single semicolon) terminates a vector. Conjunctive vectors form a matrix. A matrix-separator (double semicolon) terminates a matrix. Disjunctive matrices form a meme. Each limit may begin with an optional variable, binding the [symbol] matrix, vector, limit axis [symbol] coordinates to a symbol that later data tokens can dereference.

The wildcard (asterisk) matches any data.

The VSAME (at-sign) relative token dereferences to the data stored in same matrix, previous vector, same limit axis; or in relative [symbol] matrix, vector, limit [symbol] terms [symbol] 0, −1, 0 [symbol] .

The MSAME (caret) relative token dereferences to the data stored in the previous matrix, last vector, same limit axis; or in relative [symbol] matrix, vector, limit [symbol] terms [symbol] −1, max, 0 [symbol] . Optionally, additional relative tokens point to different sets of relative coordinates.

Various embodiments optionally comprise various other tokens representing other relative coordinates. These relative coordinate tokens relate to numerous prior figures including FIG. 15 where “an unnumbered variable is populated from previous set” as well as FIG. 18 teaching “chaining” sets.

A comparison operator (=, !, !=, >, >=, <, <=) optionally precedes each Limit to control set intersection during evaluation. A missing operator elides equality. In some embodiments, a lone operator implies an elided VSAME after; for example, “=” is expanded to “=@” for “equals same axis in previous vector.” In some embodiments, specific matrix or vector operators precede those strings.

Within a matrix, the first vector has the highest order axis, subsequent vectors are padded with VSAME, implicitly currying higher axes, akin to cylindrification. The result is a “rectangular” matrix where all vectors have the same axis count. In one embodiment, axis order descends left to right from high to low. In an alternate embodiment, axis order ascends low to high. In one embodiment, axes are zero-indexed. In an alternate embodiment, axes are one-indexed.

Conventional query languages such as SQL constrain the table name and column name to a single fixed value. The present invention allows for non-fixed values in any axis; meaning a query can be applied to multiple table names and/or the value limit applied to multiple columns.

Variables bind at parse time to lattice coordinates (e.g., matrix, vector, and limit axes) at their first occurrence. Subsequent occurrences dereference those coordinates to obtain the associated values typically later retrieved from the datastore. Each variable thus denotes a position in the lattice rather than a late-bound placeholder. This compile-time binding can reduce or eliminate the need for correlated subqueries, extensive aliasing in self-joins, and SPARQL OPTIONAL graph patterns. Further, it enables deterministic substitution prior to plan generation or execution.

In one embodiment, the positional grammar enables deterministic, single-pass parsing with time linear in the query length. Tokens are recognized by a fixed automaton that classifies characters into operators, literals, and separators with at most trivial look-ahead. Each token's axis index determines its placement in the lattice, so the parser neither backtracks nor rescans; it streams tokens into pre-allocated node arrays while performing constant-time consistency checks. Memory growth is a bounded multiple of input size, reducing runtime schema discovery, nested clause folding, and heuristic join inference. Throughput is thereby comparable to raw string copying while producing a fully validated, execution-ready intermediate.

In one embodiment, the present invention uses four axes, each corresponding to SQL conventions: Axis 3 is the table name, Axis 2 is the primary key, Axis 1 is the column name, and Axis 0 is the cell value. The mapping extends to RDF/SPARQL by aligning axes to graph/subject/predicate/object positions without changing lattice semantics. Conventional self-join syntax is replaced by a vector with VSAME or a variable in Axis 0 and a NOT-VSAME limit for the row identifier/primary key in Axis 2. Conventional other-table-join syntax is replaced by a vector with VSAME or a variable in Axis 0 and a distinct table name in Axis 3. This four-axis depiction is illustrative and the notation is parameterizable to N-axes with identical semantics. Additional axes optionally add hyperdimensional logic that can encode certainty, versioning, provenance, temporality, graph modalities, or as-yet-unknown data relationships while remaining fully parsable by the same single-pass compiler.

In one embodiment, a Memelang compiler emits a contiguous, 128-byte-aligned device buffer in which each row occupies exactly 128 bits (16 bytes) encoded as two 64-bit words: a first word w0 packs a 32-bit Axis 3 identifier and two 16-bit identifiers for Axis 2 and Axis 1, and a second word w1 stores a little-endian 64-bit Axis 0 literal. The compiler simultaneously produces a device-side offset table that maps host sentence indices (or other query references) to byte offsets in the buffer. A host processor allocates pinned memory, aligns the buffer to a 128-byte boundary, and transfers the packed rows and offset table to the GPU asynchronously via a CUDA stream. A kernel (e.g., MEME_SCAN) is launched with blockDim=128 and gridDim=ceil(N/4) for N rows; each thread processes four contiguous rows to maximize coalescing. The thread computes its global index i, derives base=4.i, performs coalesced loads of w0/w1[base . . . base+3] into shared memory, applies an in-register associative reduction (e.g., prefix-sum, min/max, or XOR fold) over the four rows without branching, and performs one global-memory write of the intermediate or final result. This layout presents a struct-of-arrays device view (w0[ ], w1[ ]) that avoids pointer chasing and enables predictable address arithmetic. Exact field widths may vary across embodiments (e.g., widening axis-2/-1), and the axis-0 payload may encode numeric or canonicalized non-numeric literals, provided the overall row size remains 128 bits. Word and row sizes vary according to embodiment.

This organization yields concrete computing benefits: (i) denser rows (16 B vs larger structured layouts) reduce host-to-device traffic and improve cache/L2 utilization; (ii) 128-byte alignment and four-rows-per-thread coalesced access reduce memory transactions and cut store pressure by ˜4× (one store per four rows); (iii) shared-memory staging plus register-level reduction minimizes divergence and round-trips to global memory; (iv) pinned, asynchronous transfers enable overlap of movement and compute; and (v) the device-side offset table supports O(1) mapping from host queries to device regions without rebuilding buffers. In representative scan/filter workloads these mechanisms provide a specific improvement in computer functionality over interpreter-style CPU traversals and over declarative engines (e.g., SQL/SPARQL) that rely on pointer-rich row stores and tokenization, delivering materially lower execution time and higher throughput at scale. Novel aspects include, in combination: (a) a fixed-width 128-bit row packing of four axes into two 64-bit words with defined endianness; (b) a compiler-emitted device offset table keyed to host query elements; (c) a four-rows-per-thread GPU schedule with a single coalesced global store following an in-register reduction; and (d) a struct-of-arrays device representation derived from the packed buffer to eliminate intermediate tokenization and pointer chasing.

In some embodiments, the packed 128-bit row buffer is exposed as one or more contiguous GPU-resident tensors without copying. For example, the compiler presents w0[ ] and w1[ ] as stride-1 device arrays of 64-bit elements (unsigned or signed) aligned to 128-byte boundaries, or as a single vectorized 16-byte element type. The mapping is effected via a zero-copy device-memory interoperability interface (e.g., a CUDA array interface or DLPack handle), enabling machine-learning runtimes to consume the lattice directly as tensors. Because the row layout is fixed-width and the engine also emits a device-side offset table, downstream kernels (e.g., feature extractors, reductions, attention-style scorers) can index, batch, and fuse operations over four-row groups per thread without host deserialization or reformatting. This eliminates intermediate tokenization and copy/convert steps, improves end-to-end throughput in training and inference pipelines, and preserves coalesced access patterns established by the MEME_SCAN schedule.

In one embodiment, the vector-separator is omitted. Axis depth is fixed and vector numbering is determined by a count of limit-separators, divided by the fixed axis depth, rounded down to the nearest integer.

In one embodiment, the vector-separator and limit separator are omitted. Each limit occupies a fixed bit length. Axis depth is a fixed integer. The absolute limit number is determined by a count of bits, divided by the fixed limit length, rounded down to the nearest integer. Vector numbering is determined by the absolute limit number, divided by the fixed axis depth integer, rounded down to the nearest integer. Axis numbering is the fixed axis depth integer, minus, the absolute limit number modulus fixed axis depth integer.

For matrices that are either input as rectangular or padded to be rectangular, relative plural coordinates are optionally condensed into a single coordinate relative to absolute limit count. For example, the relative coordinates of “same matrix, prior vector, same axis” are optionally condensed into one relative coordinate expressed as “absolute limit count minus fixed axis depth integer”; for a matrix with axis depth 4, this would condense [symbol] 0, −1, 0 [symbol] into [symbol] −4 [symbol] .

Novelty resides in the fusion of relational and graph paradigms through a positional axis grammar, the elimination of late-binding variables via coordinate-aware symbols, and the generation of uniformly shaped data structures that serve both execution engines and large language model trainers. These aspects depart materially from prior art, which relies on textual clause ordering, ad-hoc naming scopes, and optimizer-dependent execution plans. The present invention therefore delivers faster parsing, deterministic behavior, and effortless bidirectional translation, conferring significant practical advantages over existing query languages.

The present invention is novel in that the axis syntax serves both as the declarative query syntax and as the canonical form of the data it returns. Each result set is optionally encoded in the same axis syntax, allowing results to flow directly into subsequent queries without serialization, re-parsing, or schema negotiation. By unifying command and data formats, the invention enables recursive analytics, constant time pipeline composition, and deterministic replay, advantages not available in conventional languages that separate query text from result representation. The deterministic axis mapping allows lossless round-tripping of result sets back into query form, enabling recursive analytics pipelines with zero serialization or schema-negotiation overhead.

In one embodiment, the lattice is expanded to handle vector embeddings. The leftmost axis presents a collection identifier that selects the target vector database; the next axis specifies the similarity metric (for example, “cosine” or “dot”); the third axis holds a numeric threshold ≤τ, establishing the maximum admissible distance (or the minimum required similarity). Following axes, counted downward from N to 1, convey the individual components vₙ . . . v₁ of the probe embedding, thereby aligning one vector coordinate per syntax axis. Additional axes hold vector meta data such as a string value. During execution the engine computes the metric distance ρ(u,v) between each stored vector u and the probe v; the returned row comprises the vector table database identifier, ρ where ρ≤τ, each embedding value, and the relevant meta data. This axis mapping integrates nearest-neighbor retrieval into the same positional algebra used for relational and graph queries without introducing key-based fields or altering variable semantics.

The axis-based notation reduces expensive LLM compute costs by reducing the number of token length of a query string. For example, a query asking, “Which movies has Orson Welles (or “Orson”) acted in that have a rating greater than 4/5?” would be written in SQL as, SELECT actor,movie,rating FROM roles WHERE actor IN (‘Orson Welles’, ‘Orson’) AND rating>4. According to OpenAI's tokenizer, this SQL query contains 24 tokens in GPT4-o models. The equivalent axis syntax query would be roles*actor “Orson Welles”, Orson; movie*; rating>4. According to OpenAI's tokenizer, this axis syntax query contains 18 tokens in GPT4-o models, reducing the query token length by 25%.

The query in the figure depicts a JOIN query example the query asking, “Who has costarred in movies with Orson Welles?” would be written in SQL as SELECT t0.actor,t0.movie,t1.movie,t1.actor FROM roles AS t0, roles AS t1 WHERE t0.actor=‘Orson Welles’ AND t1.id!=t0.id AND t1.movie=t0.movie. According to OpenAI's tokenizer, this SQL query contains 48 tokens in GPT4-o models. The equivalent axis syntax query would be roles*actor “Orson Welles”; movie*; !@@@; actor*. According to OpenAI's tokenizer, this axis syntax query contains 19 tokens in GPT4-0 models, reducing the query token length by approximately 60%. Using this example, assuming costs of $1 per million tokens for 10 billion queries per day, the present invention over SQL reduces compute costs around $106 million per year ((48−19)*1/1,000,000*10,000,000,000*365=105,850,000).

In the depicted query, axes descend left to right. Axis 3 is analogous to a table name. Axis 2 is analogous to a row identifier or primary key. Axis 1 is analogous to a column name. Axis 0 is analogous to a cell value.

Vector 0 matches roles in which Orson Welles is the actor. Axis 3 is the table name “roles”. Axis 2 is a wildcard row identifier. Axis 1 is the column name actor. Axis 0 is the name “Orson Welles”.

Vector 1 further retrieves the movie column value with the row identifier matched from the previous vector. Axis 3 is omitted, currying forward the table name from Vector 0, Axis 3. Axis 2 is omitted, currying forward the row identifier from Vector 0, Axis 2. Axis 1 is the column name “movie”. Axis 0 is a wildcard matching any movie name.

Vector 2 performs the JOIN operation. Axis 3 is omitted, currying forward the table name from Vector 1, Axis 3. Axis 2 is the NOT operator with VSAME datum, matching a different row identifier than that of Vector 1, Axis 2. Axis 1 is VSAME, matching the same column name as Vector 1, Axis 1 (“movie”). Axis 0 is VSAME, matching the same value as Vector 1, Axis 0 (the movie's name).

Vector 3 further retrieves the actor name from matching the new row identifier. Axis 3 is omitted, currying forward the table name from Vector 2, Axis 3. Axis 2 is omitted, currying forward the new row identifier from Vector 2, Axis 2. Axis 1 is the column name “actor”. Axis 0 is a wildcard matching any actor name.

### Example Code

The attached computer code is one prototype embodiment of the present invention encoded in Python. However, the present invention may be encoded in any number of computer programming languages may utilize any number of database programs. Those skilled in the art will recognize the present invention is optionally embodied in a purpose-written database program.

### Preferred Components of the Invention

The following describes some of the components variously used in certain embodiments of the present invention. Certain embodiments use additional components not listed here.

In one embodiment, the present invention is delivered as an application programming interface (API) that exposes a stable set of local and network endpoints. These endpoints accept request objects, invoke the core processing pipeline, and return machine readable responses, thereby allowing external software to embed the functionality of the present invention without recompiling or linking native libraries.

In one embodiment, the present invention incorporates artificial intelligence (AI). Large language models such as GPT-3 by OpenAI, DALL-E, Stable Diffusion, MidJourney, and DeepMind systems are integrated to translate natural-language instructions into executable requests and to summarize structured results, providing conversational access and predictive analytics that enhance overall system performance.

In one embodiment, the present invention ingests audio data. Digital assets encoded in 3GP, AA, AAC, MP3, OGG, WAV, WMA, WEBM, or similar formats are stored together with descriptive metadata, enabling unified search, transformation, and analytics across multimedia and non-media data through the same processing framework.

In one embodiment, the present invention indexes Bitcoin (BTC) ledger information. Block headers, transactions, and outputs are transformed into structured records so that cryptographic proofs, balance checks, and historical queries execute within the same runtime that services conventional relational workloads.

In one embodiment, the present invention interfaces with blockchain networks, including but not limited to Ethereum, Polygon, Binance, Ripple, Cardano, Solana, Polkadot, Near, Avalanche, Litecoin, Monero, Optimism, and Lightning Network. By mapping blocks and timestamps into canonical data structures, the system performs cross-chain auditing, provenance tracking, and real-time analytics without external middleware.

In one embodiment, the present invention commits arbitrary application records to a blockchain ledger by serializing each record into a fixed-length tuple whose fields respectively identify the logical dataset, the record key, the attribute name, and the literal value, concatenating those fields into a fixed-bit payload, embedding the payload in the data region of a transaction output, and broadcasting the signed transaction to the peer to peer network. Each block that later confirms the transaction immutably anchors the tuple, and subsequent queries reconstruct the original record set by scanning the ledger for outputs bearing the dataset tag. Because the tuple ordering is deterministic and uniform, no external schema registry or off chain index is required, thereby enabling censorship resistant storage, verifiable audit trails, and atomic sharing of structured data among untrusted parties.

In one embodiment, the present invention manages blockchain addresses. Each hexadecimal identifier, such as 0x1234ABC, is stored alongside its corresponding public-key hash and balance metadata, allowing deterministic address resolution, transaction correlation, and risk scoring across multiple chains.

In one embodiment, the present invention executes blockchain smart contracts. Transactions targeting on-chain programs, for example Solidity contracts on Ethereum or Rust programs on Solana, are automatically constructed, signed, and submitted, and subsequent receipts are captured and recorded for deterministic replay, audit, and downstream processing.

In one embodiment, the present invention mints and manages blockchain tokens-coins or cryptocurrencies-that mirror asset state changes produced by its core processing pipeline. When the system records a qualifying event, it invokes an on-chain smart contract to issue a corresponding token conforming to widely adopted Ethereum standards such as ERC-20 fungible tokens, ERC-721 non-fungible tokens, or ERC-1155 semi-fungible tokens. Each token's immutable ledger entry acts as a cryptographic receipt that links ownership, provenance, and transactional metadata back to the off-chain dataset handled by the present invention, enabling verifiable asset tracking, automated royalty distribution, and permissioned access controls without relying on centralized intermediaries.

In one embodiment, the present invention incorporates a client, network client, or computer client, defined as a computing device that originates a service request across a network to a server executing the present invention. The client packages user credentials, payload data, or natural-language instructions into a protocol message, transmits that message over secure transport such as HTTPS or gRPC, and awaits a structured response that may include analytic results, authentication tokens, or blockchain transaction receipts. By offloading computationally intensive parsing, inference, and ledger interaction to the server, the client maintains a lightweight footprint suitable for browsers, mobile applications, embedded systems, and edge devices while still benefiting from the full functionality of the present invention through a stateless request-response paradigm.

In one embodiment, the present invention is realized as a synchronous digital circuit whose pipeline stages—request buffering, lexical decoding, semantic expansion, and result emission—are driven by a clock signal or logic signal. A square-wave clock generated by an on-chip oscillator provides a stable cadence, and each rising edge propagates tokens through flip-flops and latches that align the parser, comparator, and serializer units, thereby preventing race conditions during high-throughput streaming. For double data rate implementations, both the rising and falling edges are exploited to process separate halves of a request sentence in parallel, doubling effective bandwidth while maintaining deterministic timing. The constant-frequency clock also gates the optional GPU-launch sequencer and blockchain transaction engine, ensuring that off-chip bus handshakes occur at precise intervals, so the hardware embodiment of the present invention achieves low-latency, race-free operation across all synchronized subsystems.

In one embodiment, the present invention is delivered through cloud computing, allowing users to provision its full parsing, analytics, and ledger-interaction capabilities on demand over a wide-area network. A managed control plane spins up elastic compute instances, attaches high-throughput storage, and exposes secure HTTPS or gRPC endpoints so that clients can submit requests without maintaining local infrastructure. Autoscaling groups monitor workload metrics and automatically add or retire virtual machines, while container orchestration platforms such as Kubernetes or ECS deploy stateless microservices that host the core runtime, AI assistants, GPU kernels, and blockchain gateways. This cloud architecture provides pay-as-you-go elasticity, geographic redundancy, and continuous deployment, ensuring that the present invention scales seamlessly from a single proof-of-concept to global, high-availability production environments.

In one embodiment, the present invention incorporates a code generator that transforms the runtime's intermediate representation into an executable artifact suitable for downstream execution environments. Upon receiving a validated request, the generator emits target-specific source code, assembly, bytecode, or machine code, for example SQL statements for relational engines, CUDA kernels for parallel GPUs, or Solidity bytecode for blockchain smart contracts. The generated program is optimized in situ through constant folding, dead-path elimination, and register allocation informed by the deterministic structure of the intermediate form, after which it is compiled or linked by the appropriate toolchain and delivered for immediate execution. This integrated code-production capability allows the present invention to adapt its analytic and transactional workflows to heterogeneous hardware and software platforms without manual recoding, thereby providing a scalable, portable, and performance-tuned deployment path. An example code generator is the Hyperpiler disclosed in U.S. Pat. No. 10,942,709.

One embodiment of the present invention comprises a computer or computing device or computing system. A computer is a physical device comprising at least one computer-readable storage medium and at least one processor. A computer operates by reading input data from a computer-readable storage medium, reading instructions from a computer readable storage medium, and executing the input data and instructions with the processor to produce output data. Output data is typically stored in a computer-readable storage medium and/or outputted to a user. Computer form factors include desktops, laptops, smart phones, smart watches, and servers.

One embodiment of the present invention comprises a computer network or network. A computer network is two or more computers communicating. Network data may be sent as electric pulses over copper wire, light pulses over optical fiber, and/or radio waves over the air.

One embodiment of the present invention comprises a computer-readable storage medium or computer data storage medium or CRSM or storage. A computer-readable storage medium is a physical device containing input data and/or instructions for use by a computer. Common CRSMs include hard drives (HDD), solid state drives (SSD), flash drives, tape drives, magnetic tape, Compact Discs (CD), Digital Video Discs (DVD), Blu-ray® discs, optical drives, floppy disks, zip drives, random access memory (RAM), read only memory (ROM), and punch cards.

One embodiment of the present invention comprises a convolutional neural network or ConvNet or CNN. A convolutional neural network is a class of artificial neural network (ANN), most commonly applied to analyze visual imagery.

One embodiment of the present invention comprises CRUD or create/read/update/delete or manipulate. CRUD are the four basic operations on stored data. In SQL, these terms typically correspond to INSERT, SELECT, UPDATE, and DELETE. In HTTP, these terms typically correspond to POST, GET, PUT, DELETE.

One embodiment of the present invention comprises cryptography. Cryptography is the practice and study of techniques for secure communication in the presence of adversarial behavior. In computer science, common cryptographic techniques include Diffie-Hellman, X.509, Rivest-Shamir-Adleman (RSA), and Elliptic-curve cryptography (ECC), and Elliptic Curve Digital Signature Algorithm (ECDSA).

In one embodiment, the present invention integrates an adaptive data-compression layer that reduces the size of payloads, intermediate tensors, and returned result sets before they are transmitted across networks, written to cloud object stores, or embedded in blockchain transactions. The layer selects the most appropriate codec on the fly—such as ZIP, GZIP, LZ4, Brotli, or Snappy—using heuristics derived from content type and latency constraints. By shrinking message footprints, the compression subsystem lowers bandwidth usage, shortens end-to-end response time, and cuts storage and gas costs while preserving bit-exact fidelity when required, thereby enhancing the overall efficiency and scalability of the present invention.

In one embodiment, the present invention operates in conjunction with a database management system such as MySQL, PostgreSQL, SQLite, MariaDB, Couchbase, Redis, MongoDB, or HBase, the DBMS manipulating an organized set of data stored on a computer-readable medium. Within this environment the database contains one or more tables, each table being an ordered collection of rows, each row (also called a tuple) comprising one value per column, and each value representing a single cell. A column is therefore the homogeneous set of values that occupies a common position in every row, while a cell is the intersection of a specific row and column. The DBMS exposes query and update operations that the present invention invokes to read, write, and transform these cells in service of its higher-level functionality.

One embodiment of the present invention comprises a database right. A database right is a sui generis property right, comparable to but distinct from copyright, that exists to recognize the investment that is made in compiling a database, even when this does not involve the creative aspect that is reflected by copyright. Such rights are often referred to in the plural: database rights. The Agreement on Trade-Related Aspects of Intellectual Property Rights (TRIPS) Agreement requires that copyright protection extends to databases and other compilations if they constitute intellectual creation by virtue of the selection or arrangement of their contents, even if some or all of the contents do not themselves constitute materials protected by copyright.

One embodiment of the present invention comprises a download. A download is the transmission of data from a server computer to a client computer over a network.

One embodiment of the present invention comprises Ethernet. Ethernet is a family of wired computer networking technologies commonly used in local area networks (LAN), metropolitan area networks (MAN) and wide area networks (WAN).

In one embodiment, the present invention employs hash functions to convert variable-length input into fixed-length digests that secure data integrity, drive content-addressable storage, and accelerate index lookups. When the system stores payloads, serializes transactions, or transmits information over untrusted links, it invokes software or hardware implementations of standard hashes such as Secure Hash Algorithm 2 (SHA-2), Message Digest Algorithm 5 (MD5), and the 32-bit Cyclic Redundancy Check (CRC-32). The resulting digests allow receivers to confirm that a payload has not been altered in transit and permit the runtime to deduplicate identical objects without reprocessing their full contents, thereby increasing throughput and reducing storage overhead.

One embodiment of the present invention comprises HTML or HyperText Markup Language. HTML is the standard markup language for displaying documents in a web browser.

One embodiment of the present invention comprises an IDE or integrated development environment. An IDE is a software application that provides comprehensive facilities to computer programmers for software development, typically consisting of a source code editor, build automation tools, and a debugger.

One embodiment of the present invention comprises an input device. An input device is a physical device which initiates a computer execution. Such execution includes storing data, storing instructions, and/or selecting instructions and data to execute in the future. Input devices include computer keyboards, keypads, computer mice, touch screens, microphones, cameras, card readers, scanners, bar code readers, chip readers, magnetic tape readers, network modem (wired or wireless), and Bluetooth® receiver.

One embodiment of the present invention comprises the Internet. The Internet is the global system of interconnected computer networks that uses the TCP/IP protocol to communicate.

One embodiment of the present invention comprises an Internet Protocol address or IP address. An Internet Protocol address is a unique number identifying a computer connected to the Internet. Internet Protocol version 4 (IPv4) addresses comprise 32 bits. Internet Protocol version 6 (IPv6) addresses comprise 128 bits.

One embodiment of the present invention comprises the IoT or Internet of Things. The IoT describes physical objects with sensors, processing ability, software and other technologies that connect and exchange data with other devices and systems over the Internet or other communications networks.

In one embodiment, the present invention integrates a knowledge graph-a graph-structured knowledge base that represents data as interconnected nodes and edges, thereby capturing rich semantics, relationships, and ontologies among objects, events, situations, and abstract concepts. By expressing facts in this topology, the system enables context-aware reasoning, entity resolution, and inference over large, heterogeneous datasets. Popular frameworks that illustrate the paradigm include the Vadalog reasoning engine, Google's Freebase, the YAGO ontology, and the W3C-standard Resource Description Framework (RDF); the present invention adopts compatible serialization formats so it can ingest, enrich, and query external knowledge sources with minimal transformation.

One embodiment of the present invention comprises a language model. A language model is a probability distribution over sequences of words. Given any sequence of words, a language model assigns a probability to the whole sequence. Language models are often used to respond in human language to a human language prompt. GPT-3 is an example language model.

One embodiment of the present invention comprises linear regression. Linear regression is a linear approach for modelling the relationship between a scalar response and one or more explanatory variables (also known as dependent and independent variables). The case of one explanatory variable is called simple linear regression; for more than one, the process is called multiple linear regression.

One embodiment of the present invention comprises low code or no code. Low code describes a software development process by which a computer program executes computer instructions according to non-code input from a user, typically inputted though a graphical user interface. Ideally, a no code program allows a user to design a computer program without knowing complicated code syntax.

One embodiment of the present invention comprises machine learning or ML. Machine learning algorithms build a model based on sample data, known as training data, in order to make predictions or decisions without being explicitly programmed to do so. Machine learning algorithms are used in a wide variety of applications, such as in medicine, email filtering, speech recognition, agriculture, and computer vision, where it is difficult or unfeasible to develop conventional algorithms to perform the needed tasks.

One embodiment of the present invention comprises a markup language. A markup language is a syntax for annotating a document in a way that is visually distinguishable from the content. Markup languages typically do not contain executable instructions. Example markup languages include HTML, LaTeX, and Markdown.

One embodiment of the present invention comprises metadata. Metadata is data that provides information about other data, but not the content of the data itself. Metadata may describe the format, size, compression, authorship, ownership, copyright, legal, creation date, modification date, ordering, keywords, permissions, or other information about the primary data.

One embodiment of the present invention comprises a microprocessor. A microprocessor is a special case processor that converts a digital electric input signal into a digital electric output signal through a clock-driven integrated circuit comprising logic gates. Example commercial microprocessors include the Intel 4004, the Intel Pentium line, the IBM PowerPC line, and the Motorola 68000.

One embodiment of the present invention comprises a mobile application or mobile app. A mobile application is an application that runs on a portable computer. Example mobile application operating systems include Apple iOS and Google Android.

One embodiment of the present invention comprises multimedia. Multimedia computer file formats include DOC, DOCX, FLV, HTML, ODP, PDF, PPT, and PPTX.

In one embodiment, the present invention is deployed on a multitenant computer system, meaning a single physical or virtual server runs the same software stack for multiple discrete tenants-whether separate companies or independent developer groups within one enterprise. Tenant isolation is enforced through namespace partitioning, dedicated authentication realms, and role-based access controls, while shared compute, memory, and network pools are dynamically scheduled to maximize hardware utilization. This multitenant architecture enables the present invention to offer cost-efficient, scalable service instances without deploying separate infrastructure per tenant, yet guarantees that the activities of one tenant cannot compromise the confidentiality, integrity, or availability of another tenant's workloads.

One embodiment of the present invention comprises a network protocol or protocol. A network protocol is a predefined signal syntax allowing two computers to communicate over a network. Protocols may be implemented by software, hardware, or both. Protocols are typically ‘layered,’ wherein more specific protocols are transmitted within more generic protocols. Example protocols include Address Resolution Protocol (ARP), Internetwork Packet Exchange (IPX), Transmission Control Protocol (TCP), Internet Protocol (IP), User Datagram Protocol (UDP), HyperText Transfer Protocol (HTTP), Secure Socket Layer (SSL), Transport Layer Security (TLS), File Transport Protocol (FTP), Secure File Transport Protocol (SFTP), Secure Shell (SSH), Telnet, Domain Name System (DNS). Internet Control Message Protocol (ICMP), NetBIOS, Remote Procedure Call (RPC), Internet Relay Chat (IRC), Network Time Protocol (NTP), Internet Message Access Protocol (IMAP), Post Office Protocol (POP), and Simple Mail Transfer Protocol (SMTP).

One embodiment of the present invention comprises a network router or router. A network router is a networking device that forwards data packets between computer networks. A router may itself be a computer.

One embodiment of the present invention comprises a network switch or switch or switching hub or bridging hub. A network switch is a networking device that connects other devices on a computer network by using packet switching to receive and forward data to the destination device.

One embodiment of the present invention comprises a neural network or NN or artificial neural network or ANN. A neural network is a computing system inspired by the biological neural network, typically comprising layers of neurons interconnected by synapses.

One embodiment of the present invention comprises NLP or natural language processing. NLP is the interdisciplinary subfield of linguistics, computer science, and artificial intelligence concerned with the interactions between computers and human language, in particular how to program computers to process and analyze large amounts of natural language data.

One embodiment of the present invention comprises an operating system or OS. An operating system is system software that manages computer hardware and software resources, and provides common services for computer programs. Example operating systems include Linux, Unix, Apple iOS, Apple MacOS, and Microsoft Windows.

One embodiment of the present invention comprises a processor. A processor is a physical device that deterministically executes input signals into output signals. Signals are typically electric. Signals may be digital or analog.

One embodiment of the present invention comprises a program or computer program or piece of software or software program or computer application or application or app. A program is a distinct document of software. A program may reference and execute other programs. Example programs include Microsoft Word™, WordPress®, Apple iOS™, and SQLite.

One embodiment of the present invention comprises a program specification or specification. A program specification is a data document describing the desired function of a computer program. A specification is typically processed by a code generator to output a computer program. Example specification encoding syntaxes include UML, XML, and JSON.

One embodiment of the present invention comprises a programming language. A programming language is a formal language comprising a set of strings that instruct a computer processor. There are a number of programming languages, each having a specific syntax to encode instructions. Programming languages are typically compiled to machine code for execution at the processor. Example programming languages include: ASP, BASIC, C, C #, C++, COBOL, Datalog, Erlang, Go, Haskell, Java, JavaScript, Lisp, Objective-C, Perl, Prolog, Python, PHP, Ruby, Rust, Scala, Solidity, and Vyper.

One embodiment of the present invention comprises public-key cryptography or asymmetric cryptography. Public-key cryptography is the field of cryptographic systems that use pairs of related keys. Each key pair consists of a public key and a corresponding private key. Key pairs are generated with cryptographic algorithms based on mathematical problems termed one-way functions. Security of public-key cryptography depends on keeping the private key secret; the public key can be openly distributed without compromising security.

One embodiment of the present invention comprises a recurrent neural network or RNN. A recurrent neural network is a class of artificial neural network (ANN) where connections between nodes can create a cycle, allowing output from some nodes to affect subsequent input to the same nodes.

One embodiment of the present invention comprises relational algebra. Relational algebra is a theory that uses algebraic structures for modeling data, and defining queries on it with well founded semantics. The theory was introduced by Edgar F. Codd.

One embodiment of the present invention comprises a REST or representational state transfer. A REST is an API design in which a client sends an HTTP request to a server which responds with structured data in XML, JSON, similar format.

One embodiment of the present invention comprises a search engine. A search engine is a computer program designed to search documents, typically across the World Wide Web. Example search engines include Microsoft Bing, Google, and DuckDuckGo.

One embodiment of the present invention comprises a server or web server or network server. A server is a special case computer optimized for receiving requests and sending responses over a computer network.

One embodiment of the present invention comprises SHapley Additive explanations or SHAP. SHAP is a mathematical method to explain the predictions of machine learning models. It is based on the concepts of game theory and can be used to explain the predictions of any machine learning model by calculating the contribution of each feature to the prediction.

One embodiment of the present invention comprises social media. Social media comprises interactive technologies that facilitate the creation and sharing of information, ideas, interests, and other forms of expression through virtual communities and networks. Examples include Facebook, Twitter, and YouTube.

One embodiment of the present invention comprises a social network or social networking service. A social network is a computer program storing relationships between users, typically including features such as messaging, blogging, or picture uploading. Such services include Blogger, Chess.com, ClassDojo, Discord, Facebook, GitHub, Instagram, Medium, Pinterest, Quora, Reddit, Remind, Snapchat, Stack Overflow, Steam, Telegram, TikTok, Twitch, Twitter, WeChat, WhatsApp, Wikipedia, Yammer, YouTube, and similar.

One embodiment of the present invention comprises software or computer software or computer code or code. Software is instructions stored on a computer-readable storage medium to be executed by a computer processor.

One embodiment of the present invention comprises source ranking. Source ranking is the process of ranking the importance of various training source data in explaining the output of a neural network. For example, a neural network generates a song lyric and, when queried, displays a list of websites containing similar song lyrics as a source ranking.

One embodiment of the present invention comprises SPARQL. SPARQL is a query language for querying RDF databases.

One embodiment of the present invention comprises a spreadsheet. A spreadsheet is a document containing human-readable data structured in rows and columns.

One embodiment of the present invention comprises a spreadsheet program. A spreadsheet program is a special case program for manipulating spreadsheets.

One embodiment of the present invention comprises SQL or Structured Query Language. SQL is a domain-specific computer language for manipulating data in a relational database management system.

One embodiment of the present invention comprises a training source. A training source is a data source which is used in the training of a neural network. Training sources can be in a number of media including text, image, video, audio, or other multimedia. A common type of training source is a website.

One embodiment of the present invention comprises a transformer. A transformer is a deep learning model that adopts the mechanism of self-attention, differentially weighting the significance of each part of the input data. It is used primarily in the fields of natural language processing and computer vision.

One embodiment of the present invention comprises a tuple. A tuple is a data structure comprising a list of elements, including enumerated arrays and associative arrays.

One embodiment of the present invention comprises an URL or uniform resource locator or web address. An URL is a reference to a web resource that specifies its location on a computer network and a mechanism for retrieving it. A typical URL could have the form http://www.example.com/index.html, which indicates a protocol (http), a hostname (www.example.com), and a file name (index.html).

One embodiment of the present invention comprises a user. A user is an entity initiating an execution on a computer. Typically, a user is a human interacting with an input device. Alternatively, a user is a second computer programmed to interact with the former computer.

One embodiment of the present invention comprises video. Video computer file formats include 3GP, AVI, FLV, GIF, MOV, MP2, MP4, WEBM, WMV, and similar.

One embodiment of the present invention comprises a virtual machine. A virtual machine is a virtualization/emulation of a computer system. Virtual machines are based on computer architectures and provide functionality of a physical computer. Their implementations may involve specialized hardware, software, or a combination.

One embodiment of the present invention comprises virtual reality or VR. Virtual reality is a simulated experience that employs pose tracking and 3D near-eye displays to give the user an immersive feel of a virtual world. Applications of virtual reality include entertainment (particularly video games), education (such as medical or military training) and business (such as virtual meetings). Other distinct types of VR-style technology include augmented reality and mixed reality, sometimes referred to as extended reality or XR, although definitions are currently changing due to the nascence of the industry.

One embodiment of the present invention comprises a web browser or browser or Internet browser. A web browser is a program for browsing the World Wide Web. A typically browser function is to download and render a webpage comprising HTML, JavaScript, and/or CSS. Example web browsers include Microsoft® Internet Explorer®, Microsoft Edge®, Google® Chrome™, Apple® Safari®, and Mozilla® Firefox®.

One embodiment of the present invention comprises a webhost or web host. A webhost is a special case cloud provider specializing in serving documents on the World Wide Web.

One embodiment of the present invention comprises a webpage or web page. A webpage is an HTML document on the World Wide Web.

One embodiment of the present invention comprises a website or web site. A website is a group of related web pages controlled by one legal person.

One embodiment of the present invention comprises a word processor. A word processor is a program for humans to compose human-readable documents.

One embodiment of the present invention comprises the World Wide Web or WWW or web. The World Wide Web is an information network of hyperlinked documents transmitted from web servers to client web browsers over the Internet using the HTTP protocol invented by Sir Timothy Berners-Lee in 1989 at CERN. Transmitted documents typically comprise HTML, CSS, and JavaScript.

One embodiment of the present invention comprises zero-knowledge proof or ZK proof. Zero-knowledge proof is the process by which one party (the prover) can prove to another party (the verifier) that a given statement is true while the prover avoids conveying any additional information apart from the fact that the statement is indeed true. A non-interactive zero-knowledge proof requires no interaction between the prover and verifier. These cryptographic techniques are used to bundle transactions on blockchains. Examples include NIZK, zk-SNARK, and zk-STARK.

The following website repositories are here incorporated by reference in each of their entireties: //github.com/memelang-net/memesql8; //github.com/memelang-net/memesql7; //github.com/memelang-net/memesql6; //github.com/memelang-net/memesql5; //github.com/memelang-net/memesql4; //github.com/memelang-net/memesql3; //github.com/memelang-net/memesql2; //memelang.net/01; //memelang.net/02; //memelang.net/03; //memelang.net/04; //memelang.net/05; //memelang.net/06; //memelang.net/07.

I claim as my invention the following:

1. One or more non-transitory, computer-readable storage media storing instructions that, when executed by one or more hardware processors of a computing device, cause the computing device to perform operations comprising:
receiving an input string;
parsing the input string into a plurality of tokens;
associating, in a lattice representation, each token with a coordinate set comprising
a first-axis value determined by the count of occurrences of a first separator token preceding the token and
a second-axis value determined by the count of occurrences of a second separator token between the most-recent first separator token and the token;
interpreting at least one token from the plurality of tokens as a relative token, that identifies at least one referenced coordinate set using the coordinate set associated with the relative token and at least one predefined relative axis offset value associated with the relative token;
retrieving a value associated with the referenced coordinate set;
substituting the retrieved value in place of the relative token in the lattice representation; and
emitting an output string according to the lattice representation.

2. The non-transitory, computer-readable storage media of claim 1, wherein the retrieved value is at least one token from the input string retrieved from the same non-transitory, computer-readable storage media.

3. The non-transitory, computer-readable storage media of claim 1, wherein the output string is executed against a datastore on the same non-transitory, computer-readable storage media.

4. The non-transitory, computer-readable storage media of claim 1, wherein the output string is executed against a datastore on a distinct non-transitory, computer-readable storage media.

5. The non-transitory, computer-readable storage media of claim 1, wherein the retrieved value is retrieved from a distinct non-transitory, computer-readable storage media.

6. The non-transitory, computer-readable storage media of claim 1, wherein retrieved value is interpreted as a plurality of values, each value forming a distinct output string, forming a plurality of output strings on one or more non-transitory, computer-readable storage media.

7. One or more non-transitory, computer-readable storage media storing instructions that, when executed by one or more hardware processors of a computing device, cause the computing device to perform operations comprising:
receiving an input string;
parsing the input string into a plurality of tokens;
associating, in a lattice representation, each token with a coordinate set comprising
a first-axis value determined by the count of occurrences of a separator token, divided by a fixed axis-depth integer, and rounded down to an integer and
a second-axis value determined by the count of occurrences of a separator token, moduloed by the fixed axis-depth integer
interpreting at least one token from the plurality of tokens as a relative token, that identifies at least one referenced coordinate set using the coordinate set associated with the relative token and at least one predefined relative axis offset value associated with the relative token;
retrieving a value associated with the referenced coordinate set;
substituting the retrieved value in place of the relative token in the lattice representation; and
emitting an output string according to the lattice representation.

8. The non-transitory, computer-readable storage media of claim 7, wherein the retrieved value is at least one token from the input string retrieved from the same non-transitory, computer-readable storage media.

9. The non-transitory, computer-readable storage media of claim 7, wherein the output string is executed against a datastore on the same non-transitory, computer-readable storage media.

10. The non-transitory, computer-readable storage media of claim 7, wherein the output string is executed against a datastore on a distinct non-transitory, computer-readable storage media.

11. The non-transitory, computer-readable storage media of claim 7, wherein the retrieved value is retrieved from a distinct non-transitory, computer-readable storage media.

12. The non-transitory, computer-readable storage media of claim 7, wherein retrieved value is interpreted as a plurality of values, each value forming a distinct output string, forming a plurality of output strings on one or more non-transitory, computer-readable storage media.

13. One or more non-transitory, computer-readable storage media storing instructions that, when executed by one or more hardware processors of a computing device, cause the computing device to perform operations comprising:
receiving an input binary;
parsing the input binary into a plurality of fixed-bit-length words;
associating each word with a coordinate set comprising
a first-axis value determined by the order position of the word, divided by a fixed axis-depth integer, and rounded down to an integer and
a second-axis value determined by the order position of the word, moduloed by the fixed axis-depth integer
interpreting at least one word from the plurality of fixed-bit-length words as a relative word, that identifies at least one referenced coordinate set using the coordinate set associated with the relative word and at least one predefined relative axis offset value associated with the relative word;
retrieving a value associated with the referenced coordinate set;
replacing, in the input binary, the retrieved value in place of the relative word, forming an output binary; and
emitting the output binary.

14. The non-transitory, computer-readable storage media of claim 13, wherein the retrieved value is at least one word from the input binary retrieved from the same non-transitory, computer-readable storage media.

15. The non-transitory, computer-readable storage media of claim 13, wherein the output binary is executed against a datastore on the same non-transitory, computer-readable storage media.

16. The non-transitory, computer-readable storage media of claim 13, wherein the output binary is executed against a datastore on a distinct non-transitory, computer-readable storage media.

17. The non-transitory, computer-readable storage media of claim 13, wherein the retrieved value is retrieved from a distinct non-transitory, computer-readable storage media.

18. The non-transitory, computer-readable storage media of claim 13, wherein retrieved value is interpreted as a plurality of values, each value forming a distinct output binary, forming a plurality of output binaries on one or more non-transitory, computer-readable storage media.

19. One or more non-transitory, computer-readable storage media storing instructions that, when executed by one or more hardware processors of a computing device, cause the computing device to perform operations comprising:
receiving an input token stream comprising at least one separator token and at least two datum tokens;
mapping, in a single deterministic pass without backtracking, each datum token to coordinates of a multi-axis lattice according to axis-index semantics driven by separator token positions;
padding at least one omitted axis by currying at least one datum token mapped to a corresponding prior axis; and
writing the lattice to non-transitory, computer-readable storage media.

20. The non-transitory, computer-readable storage media of claim 19, wherein padding the omitted axis comprises inserting a symbolic reference token that dereferences to prior coordinates.

21. The non-transitory, computer-readable storage media of claim 19, wherein the separator tokens are interpreted by mixed-radix axis-index arithmetic with carry between axis counters.

22. The non-transitory, computer-readable storage media of claim 19, wherein the operations further comprise emitting the stored lattice as a token stream in the same syntax as the input token stream.

23. The non-transitory, computer-readable storage media of claim 21, wherein the operations further comprise emitting the stored lattice as a token stream in the same syntax as the input token stream.
